(19) United States
(12) Patent Application Publication
(10) Pub. No.: US 2026/0329823 A1
(43) Pub. Date: Oct. 22, 2026

(54) SYSTEM

(71) Applicant: SoftBank Group Corp., Tokyo (JP)

(72) Inventor: Ayumu KURODA, Tokyo (JP)

(73) Assignee: SoftBank Group Corp., Tokyo (JP)

(21) Appl. No.: 19/646,613

(22) Filed: Apr. 14, 2026

(30) Foreign Application Priority Data
Apr. 22, 2025 (JP) 2025-070619

(51) Int. Cl. G06F 16/215; G06F 16/242; G06N 3/092

(52) U.S. Cl. CPC G06F 16/215; G06F 16/243; G06N 3/092

(57) ABSTRACT

The present invention relates to an integrated scenario simulation system that supports prompt and highly convincing decision-making by automatically collecting and integrating financial data, customer data, sales data, behavior logs, social media information, news, economic indicators, and the like from various data sources inside and outside a company, generating a structured dataset through preprocessing and feature extraction, multidimensionally simulating complex business scenarios such as new business introduction, existing business growth, and risk management using a generative AI, outputting sales, profits, risks, optimal measures, and the like in a natural language and numerical values, and integrally realizing visualization, basis explanation, interactive operation, and automatic report generation on a dashboard.

### CROSS-REFERENCE TO RELATED APPLICATION

The present application claims priority to and incorporates by reference the entire contents of Japanese Patent Application No. 2025-070619 filed in Japan on Apr. 22, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

The problem to be solved by the present invention is to integrally and drastically solve complex and serious problems inherent in the overall data utilization, AI utilization, and decision-making processes in modern corporate management using a generative AI and a data integration platform, such as that a wide variety of data in corporate activities are divided and siloed for each department and each system, making overall optimal decision-making difficult, that in an unpredictable era called VUCA, the accuracy of future prediction significantly decreases in business planning and risk management based on conventional experience and simple statistical analysis, making it impossible to perform a scenario analysis that sufficiently considers complex causal relationships and changes in the external environment, that furthermore, collecting information necessary for decision-making and coordinating with related departments require an enormous amount of time and effort, delaying prompt management decisions and risk responses, that in addition, advanced analysis and simulation utilizing an enormous amount of data require specialized knowledge and an enormous amount of man-hours, making it difficult for front-line personnel and management to select a measure intuitively and convincingly, and that the basis and process of data-based scenario simulation and risk evaluation are likely to become a black box, hindering decision-making with high accountability and convincingness.

### SUMMARY OF THE INVENTION

A means for solving the problem is to construct a system comprising a data integration unit, a generative AI scenario simulation unit, and a visualization and interpretation unit, wherein the data integration unit is configured to automatically collect data from a plurality of types of internal and external data sources such as a financial accounting system, a customer management system, a sales management system, behavior logs of websites and applications, social media data, news articles, and economic indicators, perform preprocessing such as deletion of duplicate data, imputation of missing values, detection and removal of abnormal values, and standardization of numerical data while absorbing differences in data formats and granularities to aggregate the data into an integrated database, and further execute feature extraction and dimensionality reduction to generate a structured dataset suitable for AI analysis; the generative AI scenario simulation unit is configured to receive the integrated dataset and a business scenario input in a natural language by a user as a prompt, and output, in a natural language, a future prediction and a risk analysis regarding various business scenarios such as new business introduction, existing business growth, and risk management using a generative AI while considering complex causal relationships and interactions such as past similar case data, market trends, customer attributes, competitive situations, and economic environments; and the visualization and interpretation unit is configured to display a predicted value, a risk evaluation, an optimization measure plan, and the like output by the generative AI as a graph or a chart on a dashboard, further display a determination basis and a thinking process of the AI together as an explanatory text or a link to basis data so that the user can make a decision intuitively and convincingly, and include a natural language interface and an automatic report generation function so that a scenario analysis and a measure proposal can be executed in a chat format without specialized knowledge.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor indicated by reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), among others.

In the following embodiments, a RAM (Random Access Memory) indicated by reference numeral is a memory where information is temporarily stored and used as a work memory by the processor.

In the following embodiments, a storage indicated by reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) indicated by reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

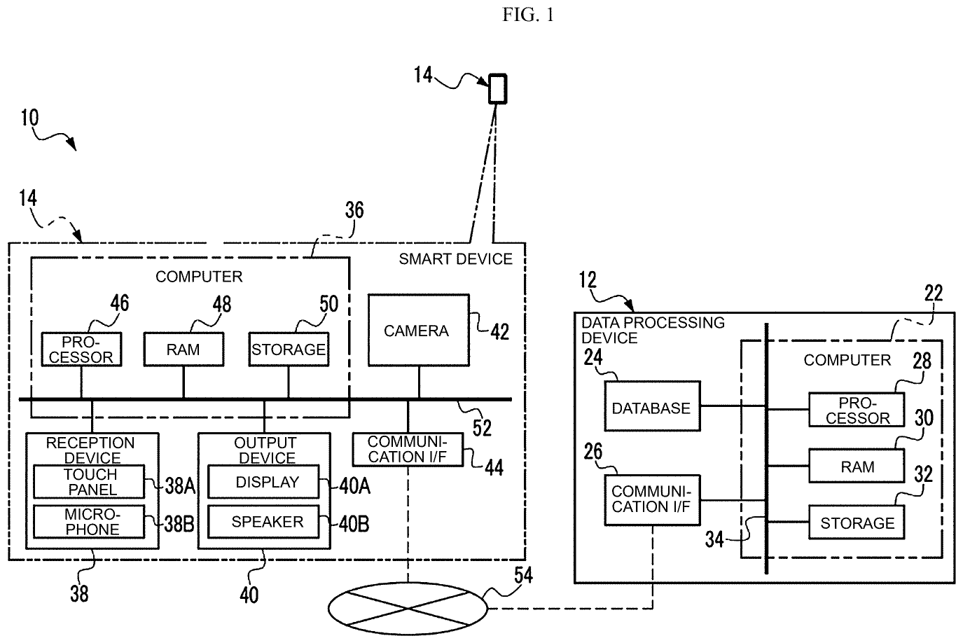

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, camera 42, and communication I/F 44 are also connected to the bus 52.

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A in the processor 46 sends data indicating user input accepted by the touch panel 38A and microphone 38B to the data processing device 12. In the data processing device 12, the specific processing unit 290 acquires data indicating user input.

The output device 40 comprises a display 40A and a speaker 40B, among others, and presents data to the user 20 by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

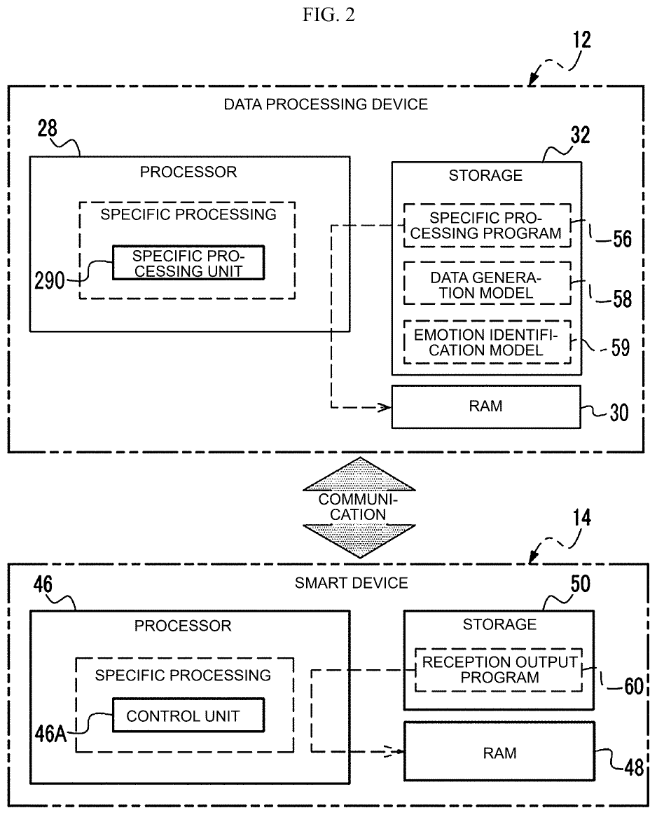

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart device 14, reception output processing is performed by the processor 46. The storage 50 stores a reception output program 60. The reception output program 60 is used in conjunction with the specific processing program 56 by the data processing system 10. The processor 46 reads the reception output program 60 from the storage 50 and executes it on the RAM 48. The reception output processing is realized by the processor 46 operating as a control unit 46A according to the reception output program 60 executed on the RAM 48. The smart device 14 may also have similar data generation models and emotion identification models as the data generation model 58 and emotion identification model 59, and perform the same processing as the specific processing unit 290 using these models. The reception output processing is realized by the processor 46 operating as the control unit 46A according to the reception output program 60 executed on the RAM 48.

Other devices besides the data processing device 12 may have the data generation model 58.

For example, a server device (e.g., a generation server) may have the data generation model 58.

In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example 1

The flow of the specific processing in Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments for carrying out the present invention will be described more specifically and in detail, adding thickness at random.

The system of the present invention is basically configured such that functions are shared between a server and a terminal, main processing functions of a data integration unit, a generative AI scenario simulation unit, and a visualization and interpretation unit are implemented on the server side, and functions such as a user interface, a dashboard display, user input reception, and report viewing are implemented on the terminal side. The server can be constructed in a cloud environment, an on-premises environment, or a hybrid environment, and the terminal can be realized by various devices such as a personal computer, a tablet, a smartphone, and a dedicated terminal. Specifically, the present system adopts a hardware configuration including a parallel computing cluster using an image processing processor and a large-capacity volatile memory on the server side. The present system executes data transfer between the respective processing units via high-speed internal bus communication. The present system executes dynamic screen drawing processing using a rendering engine of a web browser on the terminal side. The present system adopts a secure bidirectional communication protocol and a remote procedure call as a communication protocol between the server and the terminal. The present system adopts a microservice architecture that divides each function as an independent service as a software architecture on the server side. The present system dynamically manages an execution environment of each service using a container orchestration technology. The present system automatically scales out or scales in computing resources in accordance with an increase or decrease in traffic. The present system dramatically improves scalability of the entire system by adopting such a distributed processing architecture. The present system makes it possible to utilize enormous computing power on the server side while minimizing a processing load on the terminal side. As a result, the present system exhibits a technical effect of reducing response latency to an input from a user to the utmost limit. The present system is applied as a company-wide decision-making support platform in a large-scale enterprise environment.

First, the data integration unit is realized on the server, and automatically collects data from various internal and external data sources of a company. For example, sales data, cost data, a profit margin, profit and loss by department, monthly/quarterly/annual financial indicators, and the like are acquired from a financial accounting system by an API or batch processing. For example, a customer ID, age, gender, a place of residence, a purchase history, an inquiry history, a cancellation history, a loyalty score, and the like are periodically collected from a customer management system. For example, a sales record by product, by store, and by region, an inventory status, a return rate, a campaign effect, and the like are acquired from a sales management system by a CSV file or database linkage. For example, an access history for each user ID, a page stay time, the number of clicks, a conversion rate, a bounce rate, an A/B test result, and the like are received by streaming in real time from behavior logs of websites and applications. For example, from social media data, the number of posts, the number of engagements, a sentiment analysis result, a remark content of an influencer, a trend word, and the like regarding an own brand and a competing brand are periodically collected using a public API of an SNS. For example, from news articles, an industry trend, a legal regulation change, disaster information, a new service announcement of a competitor, and the like are acquired by an RSS feed of an external news distribution service or web scraping. For example, from economic indicators, an exchange rate, an interest rate, an unemployment rate, a consumer price index, a business condition index, and the like are automatically downloaded from a government statistical database or a financial information service. Specifically, the present data integration unit adopts a multi-thread architecture using asynchronous input/output processing. The present data integration unit activates an independent connector process in parallel for each data source. The present data integration unit uses a distributed message queue system to receive streaming data. The present data integration unit analyzes a document object model tree of a target web page when executing web scraping. The present data integration unit executes an algorithm for extracting text data from a specific HTML tag structure. The present data integration unit dynamically adjusts a request interval using a distributed crawler control mechanism in order to avoid a rate limit of an external API. The present data integration unit temporarily stores the acquired raw data in a ring buffer area on a memory. The present data integration unit executes writing to a storage in units of chunks when a data size of the buffer area reaches a predetermined threshold value. The present data integration unit optimizes utilization efficiency of a network bandwidth by executing such asynchronous and parallel data collection processing. The present data integration unit prevents a delay of the entire system due to blocking of a single process. As a result, the present data integration unit exhibits a technical effect of being able to collect a huge amount of petabyte-class data in real time without missing. The present data integration unit is applied to use cases such as real-time monitoring of a financial market and large-scale supply chain management.

Since these data have different data formats and granularities, preprocessing such as data format conversion (for example, JSON to CSV, XML to table format, etc.), timestamp unification (for example, UTC conversion, local time correction, etc.), deletion of duplicate data (for example, deduplication by a primary key, merging of similar records, etc.), imputation of missing values (for example, previous value imputation, average value imputation, external reference value imputation, estimated imputation by machine learning, etc.), detection and removal of abnormal values (for example, outlier detection by a 3-sigma method, an IQR method, rule-based determination, a supervised anomaly detection model, etc.), and standardization of numerical data (for example, Z-score standardization, min-max normalization, logarithmic transformation, etc.) is performed on the server, and the data is aggregated into an integrated database. Furthermore, feature extraction and dimensionality reduction are also executed on the server, and for example, a moving average and seasonal adjustment of a sales transition, a purchase frequency and LTV (Life Time Value) for each customer segment, aggregation of the number of advertising contacts, a correlation analysis with an economic indicator, a principal component analysis of time-series data, customer classification by clustering, TF-IDF vectorization and embedded representation of text data, feature extraction of image data, and the like are automatically performed to generate a structured dataset suitable for AI analysis. Specifically, the present system applies a deep learning model using an autoencoder in missing value imputation processing. The present system receives an incomplete data vector as an input, and calculates a probabilistic estimated value of a missing part through encoding and decoding processing into a latent space. The present system executes an isolation forest algorithm in abnormal value detection processing. The present system divides data points by a random hyperplane, and specifies data having a short path length until isolation as an abnormal value. The present system uses a pre-trained self-attention-based language model in preprocessing of text data. The present system converts a natural language text into a 768-dimensional dense floating-point number vector. The present system uses a convolutional neural network in preprocessing of image data. The present system extracts a spatial feature map from a tensor of image pixels. The present system executes singular value decomposition on time-series data, and compresses a high-dimensional time-series matrix into a low-dimensional principal component vector. The present system combines various feature vectors generated through these processes to construct a single multidimensional tensor. The present system expands this multidimensional tensor on a memory as input data to a subsequent artificial intelligence model. The present system effectively removes noise included in data by executing such advanced mathematical transformation and dimensionality reduction processing. The present system dramatically improves a convergence speed in learning and inference of the subsequent artificial intelligence model. The present system exhibits a technical effect of significantly saving consumption of computing resources. The present system is applied to an advanced customer behavior prediction system handling multimodal data, and the like.

The generative AI scenario simulation unit is also realized on the server. For example, when a user inputs “predict sales and risks when a new service is introduced to the market” in a natural language from the terminal, this unit combines the prompt and the integrated dataset on the server side, and inputs them to a generative AI (for example, a large language model or a generative AI model). The generative AI multidimensionally analyzes complex causal relationships and interactions such as a sales transition at the time of past similar service introduction, a trend of a competitor, a change in a customer attribute, an influence of an external economic environment, a consumer reaction on an SNS, a trend of a news article, and a seasonal factor, and outputs a future predicted value of sales, a risk factor, a success probability, profitability, a potential obstacle factor, and the like as a natural language and numerical data. For example, when “analyze a sales change and optimal personnel allocation when advertising investment for an existing service is increased” is input, the generative AI comprehensively analyzes a correlation between an increase/decrease in an advertising investment amount and sales, a past campaign effect, personnel allocation optimization for each region, an advertising strategy of a competitor, a change in consumer purchasing behavior, and the like, and outputs an optimal advertising investment amount, a personnel allocation plan, an expected sales increase amount, a risk factor, and the like. Furthermore, when “estimate a business impact degree when a supply chain failure occurs”
is input, the generative AI analyzes a past supply chain failure case, a geographical distribution of a supplier, an inventory level, an alternative procurement route, a related legal regulation, external news information, and the like, and outputs a sales decrease prediction when a failure occurs, a period until recovery, a risk reduction measure, and the like. Specifically, the present generative AI scenario simulation unit adopts an ensemble configuration of a large language model equipped with a self-attention mechanism and a long short-term memory network. The present system receives, as input data, a token ID array in which a natural language prompt is divided in units of subwords and position encoding is added. At the same time, the present system receives structured data including a time-series array indicating a sales transition for the past 36 months and a 128-dimensional customer feature vector as a multimodal tensor. The present system supplies these input tensors to an input layer of the model. The present system executes a matrix product operation in a multi-layer transformer block, and extracts a non-linear correlation between input data. The present system calculates a continuous value score in a range of 0.0 to 1.0 indicating a success probability of each scenario as output data. The present system outputs a 12-dimensional floating-point number vector indicating a predicted value of sales for the next 12 months. The present system outputs an attention weight distribution vector indicating importance of a risk factor. The present system determines whether or not the output success probability score falls below 0.7 which is a predetermined threshold value as subsequent processing. When the score falls below the threshold value, the present system automatically fine-tunes an input parameter, and executes loop processing of re-simulation. The present system quantifies a causal relationship between complex variables that cannot be grasped by human cognitive ability by executing a tensor operation in such a high-dimensional space. The present system exhibits a technical effect of significantly reducing a prediction error as compared with a conventional rule-based prediction method. The present system is applied to new business development with high uncertainty and risk management of a global supply chain.

Utilization of the generative AI is not limited to mere prediction, and for example, when there is an additional question “explain a basis of this risk factor” from the user, the generative AI explains which data or logic is used as a basis for determination in a natural language, and for example, when instructed to “propose an optimal measure plan”, the generative AI generates a plurality of measure plans, and comparatively explains an expected effect and a risk of each. In addition, by incorporating a reinforcement learning mechanism, for example, it is also possible for an AI agent to repeat trial and error in a simulation environment while changing a parameter such as an advertising investment amount, pricing, and personnel allocation, automatically search for an optimal strategy that maximizes a key performance indicator, and output a result thereof as a natural language and a numerical value. For example, it is possible to search for an optimal combination by changing investment allocation to a plurality of advertising channels (TV, web, SNS, outdoor advertising, etc.), automatically generate a pricing strategy considering price elasticity, and optimize an inventory level and an ordering timing of a plurality of bases in a supply chain. Specifically, the present system adopts formulation based on a Markov decision process as an architecture of reinforcement learning. The present system defines a multidimensional vector indicating a current sales record and inventory level as a state space. The present system defines a continuous value vector indicating an increase/decrease rate of advertising expenses and a price change width as an action space. The present system calculates a linear combination of a profit maximization term and a penalty term based on a risk occurrence probability as a reward function. The present system executes a proximal policy optimization method as a learning algorithm. The present system arranges an artificial intelligence agent in a virtual simulation environment. The present system causes the agent to execute search behavior extending to tens of thousands of episodes. The present system iteratively updates a weight parameter of a policy neural network by a gradient descent method based on a reward signal obtained in each step. After learning converges, the present system infers an optimal action vector for a current state vector using the optimized policy network. The present system inputs the inferred action vector to a natural language generation module, and converts it into a measure proposal text understandable by a human. The present system exceeds a limit of a heuristic rule set in advance by a human by executing such an autonomous search algorithm. The present system exhibits a technical effect of discovering a global optimal strategy from a huge parameter space without falling into a local optimal solution. The present system is applied to a dynamic pricing system and an autonomous digital marketing optimization platform.

The visualization and interpretation unit also performs main processing on the server, and implements a dashboard display function on the terminal side. On the server side, data conversion and graph generation processing is performed to visualize a predicted value, a risk evaluation, an optimization measure plan, and the like output by the generative AI, for example, a transition of a sales prediction by a line graph, a contribution degree of a risk factor by a bar graph, a comparison of a plurality of scenarios by a radar chart, an expected effect for each measure plan by a heat map, and a time-series change by an animation chart. On the terminal side, these graphs and charts are displayed on a dashboard so that the user can understand them intuitively. In addition, a determination basis and a thinking process of the AI are displayed together on a terminal screen as an explanatory text or a link to basis data so that the user can make a decision convincingly. Furthermore, on the user interface on the terminal side, for example, a scenario input, an additional question, a condition change, a report output instruction, and the like are received in a chat format, re-analysis and report re-generation are performed on the server side, and a result is returned to the terminal in real time. Specifically, the present visualization and interpretation unit executes processing of converting a high-dimensional output tensor into two-dimensional or three-dimensional coordinate data for drawing on the server side. The present system generates vertex array data and index array data for rendering using a web graphics library. The present system serializes the generated drawing data into a lightweight data description language format, and transmits it to the terminal via a network. The present system acquires an attention map matrix from a self-attention mechanism inside an artificial intelligence model in order to extract a determination basis of the model. The present system calculates a value of each element of the attention map matrix, and calculates a contribution degree score vector for an input feature. The present system specifies a feature whose contribution degree score exceeds a predetermined threshold value, and passes metadata thereof to an explanatory text generation module. The present system parses the received drawing data on the terminal side, and dynamically manipulates a document object model to draw graphics on a screen. The present system transmits a chat input from the user to the server using an asynchronous communication protocol, receives a streaming response from the server, and differentially updates only a part of the screen. The present system significantly reduces a load on a CPU and a memory of a client terminal by adopting such a distributed rendering architecture. The present system realizes smooth animation drawing while minimizing a network transfer amount. The present system exhibits a technical effect of making an inference process of a deep learning model, which is easy to become a black box, transparent based on a mathematical basis. The present system is applied to a real-time decision-making dashboard for management and a model interpretation tool for a data scientist.

The automatic report generation function is also realized on the server side, and for example, automatically creates a report in which a current status analysis, issue extraction, a specific improvement measure and measure plan, an expected effect, a risk factor and a countermeasure thereof, and the like are summarized in an easy-to-understand manner for management and front-line personnel based on a simulation result, and enables viewing and downloading in a PDF or HTML format on the terminal side. For example, it is also possible to automatically customize a report content according to an application and a user attribute, such as a summary report for a management meeting, a detailed report for front-line personnel, a risk analysis report for a risk management department, a measure proposal report for a marketing department, and a failure response report for a supply chain department. Specifically, the present system holds an extracted numerical data array and a token sequence output by a text generation model on a memory in report generation processing. The present system reads a plurality of template files having a predefined document object model tree structure from a storage. The present system acquires a profile vector indicating an authority level and an affiliated department of the user. The present system calculates an inner product of the profile vector and a metadata vector of each template, and calculates a relevance score. The present system selects a template having the highest relevance score. The present system maps the held numerical data and text data to a placeholder of the selected template, and dynamically constructs an HTML document. The present system activates a headless browser engine as a background process of the server. The present system renders the constructed HTML document in a virtual window. The present system converts the rendered screen state into a vector graphics instruction group, and encodes it as binary data in a portable document format. The present system streaming-transfers the generated binary data in response to a download request from the terminal. The present system generates a report having a complex layout without format collapse by executing such dynamic mapping and background rendering processing. The present system exhibits a technical effect of generating a large amount of reports extending to thousands of pages in parallel and at high speed. The present system is applied to automatic generation of a compliance report for a regulatory authority in a financial institution and creation of a localized performance report for each base in a multinational company.

In addition, for example, when the user inputs “want to compare a risk and profitability at the time of simultaneous development of a new business A and an existing business B in the next term” from the terminal, past data, a competitive situation, an external environment, a customer trend, a legal regulation, a seasonal factor, and the like of both businesses are integrally analyzed on the server side, the generative AI compares risks and profitability of a plurality of scenarios, the visualization and interpretation unit generates a comparison chart and an explanation of a risk factor, and a dashboard display and a report output can be performed on the terminal side. Furthermore, for example, when instructed to “propose a business continuity plan when a specific risk factor becomes actualized”, the generative AI proposes a specific countermeasure, a recovery procedure, and a risk reduction measure based on a past disaster/failure case, an industry-standard BCP (Business Continuity Plan), and current status data of the own company, and the visualization and interpretation unit can also display them as a flowchart or a checklist on the terminal. Specifically, the present system allocates a condition parameter of each input scenario to an independent calculation thread in comparison processing of a plurality of scenarios. The present system executes inference processing of each thread asynchronously and in parallel on an image processing processor cluster. The present system combines output tensors returned from the respective threads in a shared memory area. The present system executes a cosine similarity calculation on the combined tensor group, and quantitatively calculates a difference vector between scenarios. The present system specifies a dimension in which a norm of the difference vector exceeds a predetermined threshold value, and extracts a variable corresponding to the dimension as a main fluctuation factor. The present system stores a past failure case text group in a vector space database in proposal processing of a business continuity plan. The present system converts an input text of a risk factor into an embedding vector. The present system executes an approximate nearest neighbor search algorithm on the vector space database, and extracts a past countermeasure vector having high similarity. The present system inputs the extracted countermeasure vector to a context window of a generative artificial intelligence model, combines it with a current own company data vector, and autoregressively generates a new recovery procedure text. The present system dramatically shortens a calculation time by combining such a parallel inference architecture and a vector search technology. The present system exhibits a technical effect of maximizing utilization efficiency of a multi-core processor and realizing real-time scenario comparison. The present system is applied to an emergency response simulation at the time of a large-scale disaster and evaluation of a business integration scenario in a complex M&A (Mergers and Acquisitions).

As described above, in the embodiment of the present invention, main processing such as data integration, a scenario simulation by a generative AI, visualization data generation, and automatic report generation is intensively executed on the server side, and functions such as a user interface, a dashboard display, user input reception, and report viewing are provided on the terminal side, whereby a huge amount of and various data can be integrated and analyzed in real time, an advanced scenario simulation utilizing a generative AI, intuitive visualization, basis explanation, an interactive operation, and automatic report generation can be integrally realized, and a decision-making process of a company can be drastically advanced and streamlined. Furthermore, for example, in the future, an IoT device, external sensor data, image/audio data, geospatial data, and the like are also set as integration targets, and multimodal support of a generative AI is achieved, whereby it is also possible to realize more multifaceted and precise scenario analysis and risk evaluation. Specifically, the present system includes a mechanism for projecting different types of input data into a common latent space as a multimodal-compatible architecture. The present system inputs time-series waveform data acquired from an Internet of Things sensor to a one-dimensional convolutional neural network, and extracts a feature vector. The present system inputs an RGB image tensor acquired from a surveillance camera to a vision transformer model, and extracts a spatial feature vector. The present system inputs an audio spectrogram acquired from a microphone to a speech recognition model, and extracts an acoustic feature vector. The present system concatenates feature vectors obtained from these different modalities in a combining layer. The present system learns a hidden correlation between modalities using a cross-attention mechanism. The present system inputs the learned integrated vector to a final prediction layer, and calculates a comprehensive risk score. The present system detects a minute sign missed by a single data source with high accuracy from a combination of a plurality of sensor data by executing such multimodal integration processing. The present system exhibits a technical effect of dramatically improving generalization performance and robustness of a prediction model. The present system is applied to a predictive maintenance system for an equipment failure in a smart factory and an integrated surrounding environment risk evaluation system for an autonomous driving vehicle.

### (System Configuration)

The system according to the present embodiment comprises a data integration unit, a generative AI scenario simulation unit, a visualization and interpretation unit, a user interface unit, and a report generation unit. The data integration unit has a function of automatically collecting data from various internal and external data sources of a company, and aggregating the data into an integrated database while absorbing differences in data formats and granularities. For example, sales data, cost data, a profit margin, profit and loss by department, monthly/quarterly/annual financial indicators, and the like are acquired from a financial accounting system by an API or batch processing, a customer ID, age, gender, a place of residence, a purchase history, an inquiry history, a cancellation history, a loyalty score, and the like are periodically collected from a customer management system, sales results by product/store/region, an inventory status, a return rate, a campaign effect, and the like are acquired from a sales management system by a CSV file or database linkage, an access history for each user ID, a page stay time, the number of clicks, a conversion rate, a bounce rate, an A/B test result, and the like are received by streaming in real time from behavior logs of websites and applications, the number of posts, the number of engagements, a sentiment analysis result, an influencer's statement content, a trend word, and the like regarding an own brand and a competing brand are periodically collected from social media data using a public API of an SNS, an industry trend, a legal regulation change, disaster information, a new service announcement of a competitor, and the like are acquired from news articles by an RSS feed of an external news distribution service or web scraping, and an exchange rate, an interest rate, an unemployment rate, a consumer price index, an economic trend index, and the like are automatically downloaded from economic indicators from a government statistical database or a financial information service. The data integration unit performs preprocessing such as data format conversion, timestamp unification, deletion of duplicate data, imputation of missing values, detection and removal of abnormal values, and standardization of numerical data on these data, further automatically performs a moving average and seasonal adjustment of sales transition, a purchase frequency and LTV for each customer segment, aggregation of the number of advertising contacts, a correlation analysis with an external economic indicator, a principal component analysis of time-series data, customer classification by clustering, TF-IDF vectorization and embedded representation of text data, feature extraction of image data, and the like, and generates a structured dataset suitable for AI analysis. Specifically, the data integration unit constructs a high-speed data processing pipeline by cooperative operation of hardware and software. The system uses an in-memory database to hold frequently accessed data in a cache area. The system executes a high-speed lookup algorithm using a distributed hash table in the deletion processing of duplicate data. The system calculates a hash value of each record, and discards the record when it collides with an existing hash value. The system executes a k-nearest neighbor algorithm on a parallel computing framework in the imputation processing of missing values. The system calculates a Euclidean distance between a data point having a missing value and all other data points, and adopts an average value of k data having the closest distance as an imputation value. The system completely eliminates a bottleneck of disk input/output by executing such advanced in-memory processing and parallel algorithm. The system has a technical effect of converting petabyte-class unstructured data into a structured dataset with a delay in milliseconds. The system is applied to an integrated data lake infrastructure of a financial institution that requires ultra-high-speed transaction processing.

The generative AI scenario simulation unit has a function of receiving the structured dataset generated by the data integration unit and a scenario prompt in a natural language input from the user interface unit, and executing a simulation of a complex business scenario using a generative AI. For example, when a user inputs “predict sales and risks when a new service is introduced to the market”, the generative AI multidimensionally analyzes a sales transition at the time of introducing a similar service in the past, a trend of a competitor, a change in customer attributes, an influence of an external economic environment, a consumer reaction on an SNS, a trend of news articles, a seasonal factor, and the like, and outputs a future predicted value of sales, a risk factor, a success probability, profitability, a potential obstacle factor, and the like as a natural language and numerical data. For example, when “analyze a sales change and optimal personnel allocation when advertising investment for an existing service is increased” is input, the generative AI comprehensively analyzes a correlation between an increase/decrease in an advertising investment amount and sales, a past campaign effect, personnel allocation optimization for each region, an advertising strategy of a competitor, a change in consumer purchasing behavior, and the like, and outputs an optimal advertising investment amount, a personnel allocation plan, an expected sales increase amount, a risk factor, and the like. For example, when “estimate a business impact degree when a supply chain failure occurs” is input, the generative AI analyzes a past supply chain failure case, a geographical distribution of suppliers, an inventory level, an alternative procurement route, related laws and regulations, external news information, and the like, and outputs a sales decrease prediction when a failure occurs, a period until recovery, a risk reduction measure, and the like. Furthermore, when there is an additional question “explain a basis for this risk factor” from the user, the generative AI explains in a natural language which data or logic is used as a basis for determination, and when instructed to “propose an optimal measure plan”, generates a plurality of measure plans and comparatively explains expected effects and risks of each. By incorporating a reinforcement learning mechanism, it is also possible to cause an AI agent to repeat trial and error in a simulation environment while changing parameters such as an advertising investment amount, pricing, and personnel allocation, automatically search for an optimal strategy that maximizes a key performance indicator, and output a result thereof as a natural language and numerical data. Specific examples of a prompt sentence to be read by the generative AI include “predict sales, profit, and a risk factor in time series when a new business A is introduced in the next term, and explain them together with basis data”, “present a sales transition and an optimal personnel allocation plan when advertising expenses for an existing business B are increased by 20%”, “propose a business continuity plan and a risk reduction measure when a supply chain failure occurs”, “analyze an influence on own sales and a countermeasure when a competitor C announces a new service”, and “show a factor analysis and an improvement measure when a customer churn rate increases”. Specifically, the generative AI scenario simulation unit uses a neural network model that has undergone a two-stage learning process of pre-training and fine-tuning. The system executes a masked language modeling task in pre-training, and acquires a general language expression from a large-scale corpus. The system updates a weight parameter so as to minimize a cross-entropy error function in fine-tuning, and acquires an inference capability peculiar to a business domain. The system receives, as an input, a 60-dimensional vector indicating a monthly sales array for the past five years and a 1024-dimensional tensor indicating embedding of a prompt at the time of inference. The system searches for an optimal token sequence that maximizes an output probability using a beam search algorithm. The system generates, as an output, a 12-dimensional vector indicating a predicted value of sales for each month and a floating-point number from 0.0 to 1.0 indicating a risk occurrence probability. The system immediately transmits a trigger signal to an alert generation module when the output risk occurrence probability exceeds 0.8 as subsequent processing. The system suppresses overfitting of the model by executing such a strict learning process and search algorithm. The system has a technical effect of exhibiting high generalization performance even for an unknown scenario not included in learning data. The system is applied to prediction of macroeconomic fluctuation and support for formulating an entry strategy into an emerging market.

The visualization and interpretation unit has a function of displaying the predicted value, the risk evaluation, the optimization measure plan, and the like output by the generative AI scenario simulation unit as a graph or a chart on a dashboard, and further displaying a determination basis and a thinking process of the AI together as an explanatory text or a link to basis data so that the user can make a decision intuitively and convincingly. For example, a transition of sales prediction is visualized by a line graph, a contribution degree of a risk factor is visualized by a bar graph, a comparison of a plurality of scenarios is visualized by a radar chart, an expected effect for each measure plan is visualized by a heat map, and a time-series change is visualized by an animation chart. For example, various visualizations such as a comparison graph of sales, profit, and risk for each advertising investment scenario, an impact degree map at the time of a supply chain failure, a churn rate transition for each customer segment, and a correlation chart between a competitive trend and own sales are performed. Furthermore, an explanatory text such as “because an increase in sales prediction is similar to data at the time of introducing a similar new business in the past three years” or “because a main factor of a risk factor is caused by high single dependence of a supply chain” or a link to basis data is displayed as a determination basis of the AI. Specifically, the visualization and interpretation unit executes a t-distributed stochastic neighbor embedding method or a uniform manifold approximation and projection method as a visualization algorithm for high-dimensional data. The system receives, for example, a 256-dimensional customer cluster vector as an input, and performs dimensionality reduction to two-dimensional or three-dimensional coordinate data while maintaining a topological structure. The system assigns a color code and a size parameter based on an attribute of a cluster to each calculated coordinate point. The system applies a gradient-weighted class activation mapping method in extraction processing of a determination basis. The system executes error backpropagation from a target output node toward an input layer, and calculates a gradient vector for each input feature amount. The system specifies a feature amount having a large absolute value of the gradient vector as an important factor that strongly contributed to inference. The system inserts a variable name and a contribution degree score of the specified factor into a natural language template, and automatically generates an explanatory text. The system converts a complex data structure in a high-dimensional space into a format processable by a human visual system by executing such advanced dimensionality reduction and gradient analysis algorithm. The system has a technical effect of eliminating a black box in an inference process of an artificial intelligence and ensuring reliability of a user for an output result. The system is applied to basis presentation of a diagnosis support system in a medical field and a reason explanation function of credit determination in financial examination.

The user interface unit operates on a terminal, provides an interface in a chat format in which a user can input a scenario, a condition, an additional question, a report output instruction, and the like in a natural language, and enables the user to view a visualization result and a report on a dashboard. For example, the user interface unit receives an instruction such as “I want to compare a risk and profitability at the time of simultaneous development of a new business A and an existing business B in the next term”, “I want you to propose a business continuity plan when a specific risk factor becomes actualized”, or “I want you to recalculate optimal personnel allocation when an advertising investment amount is increased by 30%”, performs re-analysis and report re-generation on the server side, and returns a result to the terminal in real time. Specifically, the user interface unit implements an event listener that constantly monitors a keystroke event and a click event of a pointing device issued from an operating system of the terminal. The system acquires a text character string input by the user into a buffer on a memory. The system encapsulates the acquired text character string into a payload in a JSON format. The system transmits the encapsulated data to an endpoint on the server side via WebSocket communication which is an asynchronous communication protocol. The system draws a progress indicator on a terminal screen during processing on the server side. The system sequentially receives response data packets returned in a streaming format from the server. The system constructs a virtual document object model based on the received data. The system calculates a difference between a real document object model indicating a current screen state and the virtual document object model. The system selectively redraws only a node in which a change is detected. The system minimizes network overhead by executing such a difference update algorithm and asynchronous communication control. The system has a technical effect of avoiding reloading of the entire screen and reducing a waiting time of the user to the utmost limit. The system is applied to an artificial intelligence assistant for customer support that requires high-frequency interaction and a trading system that requires real-time parameter adjustment.

The report generation unit automatically creates a report in which a current status analysis, issue extraction, a specific improvement measure and measure plan, an expected effect, a risk factor and a countermeasure thereof, and the like are summarized in an easy-to-understand manner for management and front-line personnel based on a simulation result, and enables viewing and downloading in a PDF or HTML format on the terminal side. For example, a report content can be automatically customized according to an application or a user attribute, such as a summary report for a management meeting, a detailed report for front-line personnel, a risk analysis report for a risk management department, a measure proposal report for a marketing department, and a failure response report for a supply chain department. Specifically, the report generation unit executes dynamic content customization processing. The system acquires an identifier of a user from an authentication infrastructure, inquires of a database, and generates a profile vector indicating an authority level and an affiliated department of the user. The system assigns a metadata vector in advance to each section (for example, a financial summary, a technical detail, a risk evaluation, etc.) constituting the report. The system executes an inner product operation between the profile vector of the user and the metadata vector of each section, and calculates a relevance score for each section. The system extracts only a section having a relevance score equal to or greater than a predetermined threshold, and arranges the section on a memory as a component of the report. The system combines the extracted components to generate a single markup language document. The system applies a cascading style sheet to the generated document to determine a visual layout. The system mathematically prevents confidential information outside the authority of the user from being included in the report by executing dynamic filtering processing based on such a vector operation. The system has a technical effect of reducing cognitive load due to information overload by providing only information optimized for each user. The system is applied to an information sharing platform in a large company having a multi-layered organizational structure and an IR (Investor Relations) material creation system that adjusts a disclosure level for an external stakeholder.

As described above, in the system according to the present embodiment, the data integration unit, the generative AI scenario simulation unit, the visualization and interpretation unit, the user interface unit, and the report generation unit organically cooperate to integrate and analyze enormous and diverse data in real time, integrally realize advanced scenario simulation utilizing a generative AI, intuitive visualization, basis explanation, interactive operation, and automatic report generation, and can drastically advance and streamline a decision-making process of a company. Specifically, the system adopts an event-driven architecture to control cooperation between the respective processing units. The system issues a processing completion event message to a central message broker when batch processing or streaming processing in the data integration unit is completed. In the system, the message broker routes the event message to the generative AI scenario simulation unit subscribing to the event message. The system transmits an instruction to a container orchestration engine triggered by reception of the event, and automatically scales out a container instance for inference processing. When the inference processing is completed, the system similarly issues a start event of subsequent processing to the visualization and interpretation unit and the report generation unit. The system constructs a data pipeline in which each processing unit operates asynchronously and loosely coupled. The system maximizes throughput of the entire system by executing such advanced orchestration control. The system has a technical effect of preventing occurrence of a bottleneck due to concentration of load on a specific module and realizing dynamic optimization of a computational resource. The system is applied to a cloud-native enterprise application infrastructure premised on continuous integration and continuous delivery.

### Implementation Steps

Step 1: Data Collection and Integration In this step, data is automatically collected from various internal and external data sources of a company such as a financial accounting system, a customer management system, a sales management system, behavior logs of websites and applications, social media data, news articles, and economic indicators, and aggregated into an integrated database on a server. For example, sales data and cost data are acquired from a financial accounting system, customer attributes and a purchase history are acquired from a customer management system, sales results by product and region are acquired from a sales management system, a user access history and a conversion rate are acquired from behavior logs of websites and applications, the number of posts and a sentiment analysis result regarding a brand are acquired from social media data, an industry trend and a legal regulation change are acquired from news articles, and an exchange rate and an economic trend index are acquired from economic indicators. Specifically, the system activates a dedicated connector process conforming to a protocol of each data source as a background daemon. The system temporarily writes raw data acquired through the connector process into a ring buffer area secured on a main memory of the server. The system constantly monitors a data filling rate of the ring buffer area. The system divides the data in the buffer into chunks of a certain size when the data filling rate reaches a threshold of 80 percent. The system generates a bulk insert instruction for the divided chunk data, and executes a batch write transaction to the integrated database. After confirming that the writing is successful, the system resets a pointer of the ring buffer and releases the memory area. The system dramatically reduces a frequency of fine write requests to the database by executing such memory buffering and batch write algorithm. The system has a technical effect of avoiding competition of transaction locks of the database and improving write throughput to the utmost limit. The system is applied to a large-scale log collection system in which millions of events occur per second and a recording system of ticker data in high-frequency trading.

Step 2: Data Preprocessing and Feature Extraction In this step, preprocessing such as data format conversion, timestamp unification, deletion of duplicate data, imputation of missing values, detection and removal of abnormal values, and standardization of numerical data is executed on the collected data on the server. Furthermore, a moving average and seasonal adjustment of sales transition, a purchase frequency and LTV for each customer segment, aggregation of the number of advertising contacts, a correlation analysis with an external economic indicator, a principal component analysis of time-series data, customer classification by clustering, TF-IDF vectorization and embedded representation of text data, and the like are automatically performed to generate a structured dataset suitable for AI analysis. Specifically, the system loads a record group extracted from the integrated database into a data frame object on a memory. The system scans each column in the data frame, and specifies a record including a NULL value or a missing value flag. The system applies a random forest regression algorithm to the specified record, and predicts and imputes a missing value from other normal feature amounts. The system activates a morphological analysis engine for a column including text data, and divides a sentence into word tokens. The system calculates an appearance frequency and an inverse document frequency of each word, and constructs a TF-IDF matrix which is a huge sparse matrix. The system executes a singular value decomposition algorithm on the constructed sparse matrix, truncates a noise component, and converts it into a low-dimensional dense feature vector. The system collectively applies a Z-score standardization operation with an average of zero and a variance of one to numerical data in vector units. The system eliminates sparsity inherent in raw data by executing such a series of mathematical conversion processing. The system has a technical effect of significantly reducing a calculation amount of a matrix product operation in a subsequent neural network and optimizing a memory usage amount. The system is applied to a multimodal customer feedback analysis system in which a natural language and numerical data are mixed.

Step 3: User Scenario Input and Prompt Generation In this step, a user inputs a scenario, an analysis condition, an additional question, and the like in a natural language through a user interface unit. For example, prompt sentences such as “predict sales and risks when a new service is introduced to the market”, “analyze a sales change and optimal personnel allocation when an advertising investment amount for an existing service is increased”, “estimate a business impact degree when a supply chain failure occurs”, “analyze an impact on company sales and a countermeasure when a competitor announces a new service”, and “show a factor analysis and an improvement measure when a customer churn rate increases” are given as specific examples. Specifically, the system inputs a natural language text string received from the user interface unit to a subword tokenizer based on a byte pair encoding algorithm. The system converts the text string into an integer token ID array. The system concatenates a token array of a system prompt defining a role and a constraint condition of a model to the head of the converted token ID array. The system further concatenates a context tensor obtained by vectorizing a past dialogue history to the end of the array. When the length of the concatenated array is less than a maximum input length of the model (for example, 4096 tokens), the system adds a padding token to generate a fixed-length one-dimensional tensor. The system adds a positional encoding vector indicating relative positional information of each token to the generated one-dimensional tensor. By executing such strict tokenization and tensor construction processing, the system converts a variable-length natural language input into a standardized mathematical format that can be processed by an artificial intelligence model. The system achieves a technical effect of preventing a context breakdown even in a complex dialogue over a plurality of turns by holding a past dialogue context in the tensor. The system is applied to an automatic drafting system for legal documents requiring advanced context understanding and an interactive requirement definition support tool.

Step 4: Scenario Simulation by Generative AI In this step, the prompt sentence and a structured dataset are input to a generative AI to execute a simulation of a complex business scenario. The generative AI multidimensionally analyzes, for example, a sales transition when a similar service was introduced in the past, a trend of a competitor, a change in customer attributes, an influence of an external economic environment, a consumer reaction on an SNS, a trend of news articles, a seasonal factor, and the like, and outputs a future sales predicted value, a risk factor, a success probability, profitability, a potential obstacle factor, and the like as a natural language and numerical data. Furthermore, when an additional prompt such as “explain a basis for this risk factor” or “propose an optimal measure plan” is input from the user, the generative AI explains in a natural language which data or logic is used as a basis for determination, generates a plurality of measure plans, and comparatively explains an expected effect and a risk of each. Specifically, the system supplies the constructed input tensor to a first embedding layer of a large language model. The system executes a large-scale matrix multiplication operation using a multi-head self-attention mechanism in each layer of transformer blocks spanning several tens of layers. The system calculates a dependency relationship between respective tokens in an input sequence, and updates a hidden state vector. The system inputs an output vector of a final layer to a linear transformation layer and a softmax function, and calculates an appearance probability distribution vector of a next token for an entire vocabulary space. The system selects one most appropriate token from the calculated probability distribution vector using a sampling method based on a temperature parameter. The system adds the selected token to an output sequence and feeds it back as an input tensor for a next step. The system iteratively executes this autoregressive inference process until a special token indicating an end is output. The system inversely converts the output token sequence into a natural language text using a decoder. By executing such an autoregressive tensor operation massively in parallel on an image processing processor, the system realizes advanced logical inference deeply dependent on a context. The system achieves a technical effect of completing a complex scenario analysis that requires several weeks for a human at a speed impossible for a human, such as several seconds to several minutes. The system is applied to an analysis of real-time threat intelligence and a dynamic portfolio optimization system under an ever-changing market environment.

Step 5: Visualization of Simulation Result and Presentation of Basis In this step, a predicted value, a risk evaluation, an optimization measure plan, and the like output by the generative AI are converted as a graph or a chart on a server, and displayed on a dashboard of a terminal. For example, a transition of a sales prediction is visualized by a line graph, a contribution degree of a risk factor is visualized by a bar graph, a comparison of a plurality of scenarios is visualized by a radar chart, and an expected effect for each measure plan is visualized by a heat map. Furthermore, a determination basis and a thinking process of the AI are displayed together as an explanatory text or a link to basis data so that the user can make a decision intuitively and convincingly. Specifically, the visualization processing unit acquires multidimensional tensor data output from a large language model and a time-series prediction model. The visualization processing unit converts the acquired multidimensional tensor data into two-dimensional vector data for drawing. In this conversion processing, the system projects a high-dimensional feature amount onto a low-dimensional space using a principal component analysis algorithm. The system dynamically calculates each pixel value on a graphical user interface based on the projected coordinate data. The neural network outputs, as the predicted value, for example, one-dimensional array data indicating a sales predicted amount for each month. The neural network outputs, as the risk evaluation, for example, a floating-point numerical value from zero to one indicating an occurrence probability of each risk factor. The neural network outputs, as the optimization measure plan, for example, normalized vector data indicating an optimal allocation ratio of advertising expenses. The visualization processing unit receives these output data and executes threshold determination processing. The visualization processing unit specifies a risk factor whose occurrence probability exceeds a predetermined threshold. The visualization processing unit generates a rendering instruction for highlighting the specified risk factor. The system transmits this rendering instruction to a graphics processing unit of the terminal. The graphics processing unit executes redrawing of a screen at high speed based on the received instruction. The system analyzes a weight matrix of an attention mechanism in order to extract the determination basis of the artificial intelligence model. The analysis unit specifies an input token having a maximum value in the weight matrix. The system searches a database for original data corresponding to the specified input token. The system dynamically generates a hyperlink to the searched original data. The system arranges the generated hyperlink on the dashboard. As a technical effect, the system significantly reduces a cognitive load required for decision-making by converting complex multidimensional data into a format visually recognizable by a human at high speed. The system brings transparency to an inference process of a deep learning model, which tends to be a black box, by visualizing an attention weight. The system minimizes a delay in screen drawing by parallel rendering using the graphics processing unit. As a specific application field, the system can be applied to a risk management operation of an investment portfolio in a financial institution. The system can also be applied to a bottleneck specifying operation of a supply chain in a manufacturing industry. In these operations, the system provides a means for instantly extracting an important insight from a huge amount of simulation results.

Step 6: Automatic Report Generation and Provision to User In this step, a report in which a current status analysis, issue extraction, a specific improvement measure and measure plan, an expected effect, a risk factor and a countermeasure thereof, and the like are summarized in an easy-to-understand manner for management and front-line personnel based on a simulation result is automatically created, and can be viewed and downloaded in a PDF or HTML format on the terminal side. For example, a report content can be automatically customized according to an application and a user attribute, such as a summary report for a management meeting, a detailed report for front-line personnel, a risk analysis report for a risk management department, a measure proposal report for a marketing department, and a failure response report for a supply chain department. Specifically, the report generation unit receives structured data including the simulation result as an input. The report generation unit includes a transformer-based deep learning model specialized for natural language generation. The deep learning model converts the input structured data into a token sequence. The deep learning model calculates a dependency relationship between tokens using a self-attention mechanism. The deep learning model autoregressively generates a natural language text along a context based on the calculated dependency relationship. The system refers to a user attribute database, and specifies an authority level and an affiliated department of a requesting user. The system dynamically adjusts an abstraction degree of a text to be generated and a frequency of a specialized knowledge term based on the specified user attribute. Input data to the deep learning model includes, for example, a time-series array of a sales prediction, an importance score vector of a risk factor, and a category ID of a measure plan. Output data from the deep learning model is, for example, a character string in a markup language format including a heading of each section, a paragraph text, and a reference ID of a chart to be inserted. The report generation unit parses the output character string. The report generation unit drives a document layout engine based on a result of the parsing. The document layout engine arranges the text and the chart along a predetermined template, and generates a final document in a binary file format. The system stores the generated document in a large-capacity non-volatile storage. The system generates a universal resource locator for accessing the stored document, and transmits it to the terminal. As a technical effect, the system eliminates a transcription error caused by human manual work by completely automating a process from data analysis to document creation. The system dramatically improves information transmission efficiency by dynamic content generation according to a user attribute. The system generates a complex report spanning several hundred pages within several seconds by executing inference processing of the deep learning model on a parallel computing cluster. As a specific application field, the system can be applied to automatic generation of a monthly performance report for a local subsidiary in each country in a multinational corporation. The system can also be applied to automatic creation of an individualized treatment plan and a risk explanatory document for each patient in a medical institution. In these use cases, the system dramatically reduces man-hours for a document creation operation requiring specialized knowledge.

### (Specific Use Case)

For example, a use case is assumed in which decision-making for nationwide deployment of a new flat-rate data communication service is supported in a corporate group operating a communication business. In this case, the data integration unit automatically collects sales data for the past several years, a profit margin, a cost structure, and profit and loss by department from a financial accounting system, customer attributes, a contract history, a cancellation rate, and a customer satisfaction score from a customer management system, a sales record by product and by region, an inventory status, and a campaign effect from a sales management system, the number of views of a new service introduction page, the number of document requests, and an application form arrival rate from behavior logs of websites and applications, the number of posts regarding the new service, the number of engagements, a sentiment analysis result, and a trend of a competitor from social media data, an industry trend, a legal regulation change, and disaster information from news articles, and a consumer price index, a business condition index, an exchange rate, and the like from economic indicators, and aggregates them into an integrated database. The data integration unit executes, on these data, data format conversion, timestamp unification, deletion of duplicate data, imputation of missing values, detection and removal of abnormal values, standardization of numerical data, a moving average and seasonal adjustment of a sales transition, a purchase frequency and LTV for each customer segment, aggregation of the number of advertising contacts, a correlation analysis with an external economic indicator, a principal component analysis of time-series data, customer classification by clustering, TF-IDF vectorization and embedded representation of text data, and the like to generate a structured dataset suitable for AI analysis. Specifically, the data integration unit establishes a connection to a plurality of distributed heterogeneous database groups using an asynchronous communication protocol. The data integration unit temporarily stores raw data extracted from each data source in a buffer area on a memory. The system converts the collected unstructured text data into a high-dimensional dense vector representation using a natural language processing model. The natural language processing model adopts, for example, a pre-trained language model based on bidirectional encoder representations. The system fine-tunes a weight parameter of this language model using a corpus peculiar to the communication industry. During the fine-tuning, the system updates a weight using a stochastic gradient descent method so as to minimize a cross-entropy error function. The data integration unit applies a missing value imputation algorithm using a recurrent neural network to time-series data. This algorithm calculates a hidden state vector from a past data sequence, and predicts a numerical value of a missing portion. The data integration unit executes an unsupervised learning model based on an autoencoder architecture for abnormal value detection. The autoencoder compresses input data into a low-dimensional latent space, and restores it to an original dimension again. The system calculates a reconstruction error between the input data and the restored data. The system flags a data point whose reconstruction error exceeds a predetermined threshold as an abnormal value. Input data to the artificial intelligence model is, for example, a time-series behavior ID array indicating a web browsing history of a user, and a word embedding matrix of a post text of social media. Output data from the artificial intelligence model is, for example, a continuous value from zero to one indicating a future cancellation probability of each customer, and an integer label indicating a cluster to which the customer belongs. The system concatenates these output results to the original dataset as a new feature amount. As a technical effect, the system significantly improves learning efficiency and inference accuracy of a subsequent prediction model by mapping heterogeneous mixed data to a unified vector space. The system extracts a non-linear data structure that cannot be discovered by a simple statistical method by advanced preprocessing using deep learning. The system dramatically shortens a preprocessing time for a terabyte-class large-scale dataset by streaming processing on a memory. As a specific application field, the system can be applied to a trade area analysis and a sales prediction operation when opening a new store in a retail industry. The system can also be applied to a pricing and risk modeling operation of a new insurance product in an insurance industry. In these fields, the system reduces a huge human cost required for data preparation, and accelerates data-driven decision-making.

Through the user interface unit, a person in charge of a corporate planning department inputs a prompt sentence “predict first-year sales, a profit, and a risk factor when a new flat-rate data communication service is deployed nationwide, and explain major success/failure factors together with basis data”. Based on this prompt and the structured dataset, the generative AI scenario simulation unit multidimensionally analyzes a sales transition when a similar service was introduced in the past, a market share fluctuation when a competitor introduced a new service, a change in customer attributes, an influence of an external economic environment, a consumer reaction on an SNS, a trend of news articles, a seasonal factor, and the like, and outputs a first-year sales predicted value, a profit predicted value, a major risk factor (for example, a price offensive of a competitor, a legal regulation change, price sensitivity of a customer, a network failure risk, etc.), a success factor (for example, clarification of a target customer segment, an effective advertising strategy, enhancement of a customer support system, etc.), and a failure factor (for example, lack of service recognition, lack of differentiation from a competitor, excessive initial investment, etc.) as a natural language and numerical data. Specifically, the scenario simulation unit converts the input natural language prompt into an integer index sequence by a tokenizer. The system inputs this index sequence to an embedding layer, and acquires a continuous-value vector representation. The system expands the structured dataset on a memory as a multidimensional tensor. The system concatenates the vector representation of the prompt and the multidimensional tensor of the structured data to generate a multimodal input feature amount. The system inputs this input feature amount to a large language model having billions of parameters. The large language model has a structure in which a plurality of layers of decoder blocks of a transformer architecture are stacked. The model calculates a self-attention mechanism in each layer, and captures a complex interaction between different elements in the input data. Input data to the model is, for example, a one-dimensional array indicating a monthly sales transition for the past sixty months, a time-series vector indicating a price fluctuation of a competitor, and a token embedding matrix of the prompt sentence. Output data from the model is, for example, a twelve-dimensional numerical vector indicating a sales predicted amount for each month of the first year, a probability distribution tensor indicating an occurrence probability of each risk factor, and a natural language token sequence explaining the success factor. The system performs inverse normalization processing on the output numerical vector to convert it into an actual amount-based numerical value. The system applies a softmax function to the output probability distribution tensor, and adjusts it so that a sum of probability values becomes one. The system converts the output token sequence into a human-readable text string by a decoder. The system transfers these output results to a subsequent visualization processing unit and report generation unit. As a technical effect, the system automatically infers an execution parameter of a complex mathematical model from an abstract instruction in a natural language, and executes an advanced simulation. The system discovers a hidden correlation lurking between numerical data and text data by simultaneously processing multimodal input data, and dramatically improves prediction accuracy. The system significantly shortens a calculation time by distributedly executing inference processing of the large language model on a cluster of graphics processing units. As a specific application field, the system can be applied to a market introduction simulation of a new electric vehicle in an automobile manufacturer. The system can also be applied to a sales prediction of a new drug and formulation of a marketing strategy in a pharmaceutical company. In these use cases, the system strongly supports decision-making for a new business with high uncertainty.

Furthermore, when the person in charge inputs an additional prompt “quantitatively show an impact degree of a price offensive of a competitor on sales among risk factors, and explain it in comparison with a past case”, the generative AI analyzes fluctuation data of company sales at the time of a past price revision of the competitor, a consumer reaction on an SNS, a report content of a news article, price elasticity for each customer attribute, and the like, quantitatively calculates the impact degree of the price offensive of the competitor on the sales, and outputs an explanation compared with the past case in a natural language. Specifically, the system receives text data of the additional prompt, and concatenates it with an immediately preceding dialogue history vector. The system supplies this concatenated vector as context information to an input layer of a large language model. The system extracts a keyword “price offensive of a competitor” included in the prompt, and dynamically generates a search query for a database. A search engine extracts time-series data and text data related to a past competitor price revision event using the generated query. The system applies an autoregressive integrated moving average model or a long short-term memory network to the extracted time-series data, and calculates a cross-correlation function between a price fluctuation and a sales fluctuation. The system executes a regression analysis using a hierarchical Bayesian model in order to calculate the price elasticity for each customer attribute. Input data to the artificial intelligence model is, for example, a time-series tensor indicating a company sales transition before and after the past price revision event, and an emotional polarity score array of a social media post during a corresponding period. Output data from the artificial intelligence model is, for example, a floating-point numerical value indicating a decrease rate of the company sales when the competitor lowers a price by ten percent, and a cosine similarity score indicating a similarity with a past similar event. The system embeds the calculated decrease rate and similarity score into a prompt template of a natural language generation module. The natural language generation module autoregressively generates a logical and fluent explanatory text based on the embedded numerical data. The system transmits the generated explanatory text to the user interface unit, and displays it on a screen. As a technical effect, the system enables the user to dynamically change a precondition of a simulation and instantly execute a sensitivity analysis of a specific variable through an interactive interface. The system provides a quantitative impact degree evaluation based on a causal relationship, not a mere correlation, by integrating a statistical causal inference algorithm and a large language model. The system discovers a non-trivial similar case that a human tends to overlook at high speed by performing a similarity calculation with a past case on a vector space. As a specific application field, the system can be applied to formulation of a dynamic pricing strategy and a simulation of a competitor countermeasure in an airline company. The system can also be applied to a prediction operation of return on investment of a promotion measure in a consumer goods manufacturer. In these fields, the system dramatically improves a response capability of a company to a rapid change in a market environment.

The visualization and interpretation unit visualizes a transition of a sales prediction output by the generative AI by a line graph, a contribution degree of a risk factor by a bar graph, a comparison of a plurality of scenarios (for example, when an advertising investment amount is changed, when a target customer segment is changed, when a service start time is moved forward, etc.) by a radar chart, and an expected effect for each measure plan by a heat map, and displays a determination basis and a thinking process of the AI as an explanatory text or a link to basis data on a dashboard. Specifically, the visualization processing unit loads a multidimensional prediction result tensor output from a large language model onto a memory. The visualization processing unit activates a data conversion module, and reformats tensor data into a specific data structure required by each graph drawing library. In drawing the line graph, the system applies a spline interpolation algorithm to a time-series predicted value array to generate a smooth curve. In drawing the bar graph, the system sorts vector data indicating the contribution degree of the risk factor in descending order, and extracts an upper element. In drawing the radar chart, the system normalizes an evaluation index vector of the plurality of scenarios, and calculates a polygonal polygon comparable on the same scale. In drawing the heat map, the system applies a color map function to a two-dimensional matrix of the measure plan and the expected effect, and converts a magnitude of a numerical value into a change in hue and saturation. Input data to the artificial intelligence model is, for example, vector data indicating a parameter difference between a baseline scenario and an alternative scenario. Output data from the artificial intelligence model is, for example, a multidimensional array including a predicted value of a key performance indicator in each scenario. The system transmits these drawing data to a front-end application operating on a web browser by asynchronous communication. The front-end application dynamically updates a document object model based on the received data, and renders an interactive graph. The system calculates gradient information of a prediction model and calculates an importance score of an input feature amount in order to present the determination basis of the artificial intelligence. The system specifies original data corresponding to a feature amount having a high importance score, and generates a link for accessing the data. As a technical effect, the system dramatically improves a data understanding speed of the user by converting a complex multidimensional simulation result into an intuitive visual representation. The system provides an environment in which the user can execute enlargement/reduction and filtering of a graph without delay by dynamic rendering at a front end. The system fulfills accountability for an inference result of a black box model by gradient-based feature amount importance calculation. As a specific application field, the system can be applied to an optimization dashboard of a power demand prediction and a power generation plan in an energy company. The system can also be applied to a monitoring screen of delivery route optimization and delay risk management in a logistics company. In these operations, the system strongly supports real-time situation grasping and rapid decision-making.

The report generation unit automatically creates a report in which a current status analysis, issue extraction, a specific improvement measure and measure plan, an expected effect, a risk factor and a countermeasure thereof, and the like are summarized in an easy-to-understand manner for management and front-line personnel based on a simulation result, and enables viewing and downloading in a PDF or HTML format on the terminal side. For example, a report content is automatically customized according to an application and a user attribute, such as a summary report for a management meeting, a detailed report for front-line personnel, a risk analysis report for a risk management department, and a measure proposal report for a marketing department. Specifically, the report generation unit acquires a numerical tensor of the simulation result and a generated natural language text group from an integrated database. The report generation unit executes a document structuring algorithm using the acquired data as an input. The system analyzes an authentication token of a user, and specifies an access authority and an affiliated role. The system selects an optimal one from among a plurality of predefined prompt templates based on the specified role. The system embeds data of the simulation result into the selected template, and constructs an input prompt to a large language model. The large language model processes the input prompt, and generates a text using a writing style and a vocabulary optimized for a designated readership. Input data to the model is, for example, a summary statistic vector of a sales prediction, a list of risk factors, and an instruction token sequence “summarize concisely for management”. Output data from the model is, for example, a character string in a structured markdown format including a paragraph text of an executive summary, a bulleted issue list, and a recommended action. The system inputs the output markdown character string to a parser, and generates an abstract syntax tree. The system adds a tag of a hypertext markup language while traversing the abstract syntax tree, and generates a document viewable on a web browser. The system further drives a portable document format conversion engine, and generates a binary file of a fixed layout suitable for printing. The system stores the generated file in a secure storage area, and issues a one-time URL for downloading. As a technical effect, the system shortens a lead time of information sharing to the utmost limit by instantly generating a customized report for various stakeholders from the same data source. The system extracts only an essential insight from a huge amount of data and reduces a cognitive load of a decision-maker by utilizing an advanced summarization capability of the large language model. The system releases a huge human resource required for report creation by completely automating a document generation process. As a specific application field, the system can be applied to automatic generation of a financial soundness evaluation report of a company in an auditing firm. The system can also be applied to a creation operation of a market research report for a client in a consulting firm. In these professional services, the system equalizes quality of documentation and dramatically improves operational efficiency.

In such a use case, specific examples of prompt sentences to be read by the generative AI include “predict first-year sales, profits, and risk factors when a new flat-rate data communication service is expanded nationwide, and explain major success/failure factors together with basis data”, “quantitatively show the degree of impact of a competitor's price offensive on sales, and explain it in comparison with past cases”, “predict changes in sales, profits, and risks when an advertising investment amount is increased by 30%, and present an optimal personnel allocation plan”, “analyze changes in sales, profits, and risks when a target customer segment is changed from 20s to 30s”, and “predict a market share acquisition effect when a service start time is moved forward by three months”. Based on these prompts, the system of the present invention integrates and analyzes a huge amount of diverse data, integrally realizes advanced scenario simulation by the generative AI, intuitive visualization, basis explanation, and automatic report generation, and can drastically sophisticate and streamline a decision-making process of a company. Specifically, the system sequentially stores these diverse prompt sentences input via a user interface in an input queue of a natural language processing engine. The system executes morphological analysis and syntactic analysis on the prompt sentences extracted from the queue, and specifies a user's requested task using an intent classification model. The intent classification model is constructed using, for example, a support vector machine or a pre-trained transformer model. The system dynamically sets an execution parameter of a back-end simulation engine in accordance with the specified task. For example, when extracting a condition “when an advertising investment amount is increased by 30%”, the system updates an input variable vector of a marketing mix modeling algorithm. The system executes a probabilistic simulation by a Markov chain Monte Carlo method using the updated variable vector. Input data to the artificial intelligence model is, for example, a scalar value of a changed advertising budget, a categorical variable indicating an age group of a target customer segment, and a timestamp of a service start time. Output data from the artificial intelligence model is, for example, a probability density function of return on investment in each scenario, a solution vector of an integer programming problem indicating optimal personnel allocation, and a time-series tensor indicating a transition of a market share. The system writes these output data to an integrated database, and transmits an event notification of processing completion to a subsequent visualization processing unit and report generation unit. The system implements a series of processing pipelines as a microservice architecture, and automatically scales out computational resources according to a load using a container orchestration tool. As a technical effect, the system provides an environment in which even a business user without programming knowledge can operate an advanced mathematical optimization model by enabling flexible condition designation in a natural language. The system simulates a plurality of scenarios in parallel and integrally evaluates the results, thereby avoiding a risk of falling into a local optimum solution and enabling a search for a global optimum solution. The system seamlessly links all processes from data integration to report generation, thereby dramatically shortening a cycle time of decision-making from several weeks to several minutes. As a specific application field, the system can be applied to a business feasibility evaluation simulation of a large-scale urban development project in a real estate developer. The system can also be applied to box-office revenue prediction of a new movie and optimization of a promotion strategy in an entertainment company. The system provides a reliable decision-making basis backed by data in these business areas involving huge investments.

(Application Example 1) The flow of the specific processing in Application Example 1 will be described. Each part of the system described below is realized by the data processing device 12 and the smart device 14. Additionally, the data processing device 12 is referred to as a “server,” and the smart device 14 is referred to as a “terminal.”

### (Embodiment for Carrying Out the Present Invention)

Embodiments for carrying out the present invention will be described more specifically and comprehensively, adding thickness at random. An object of the system of the present invention is to integrate various data related to city management in real time, perform simulation and optimization of a city management scenario using a generative AI, provide the result to a city management personnel by various visualization means and automatic report generation, and enhance safety, efficiency, comfort, and sustainability of a city. The system is mainly composed of a city data integration unit, a generative AI scenario simulation unit, and a city management visualization and interpretation unit. Specifically, the system functions as a core information processing infrastructure for realizing a smart city concept. The system continuously collects data from a group of Internet of Things devices innumerably arranged in an urban space via a streaming data processing infrastructure. In order to process the collected huge amount of data, the system adopts a distributed computing framework and executes parallel processing by a plurality of arithmetic nodes. The city data integration unit converts sensor data transmitted by heterogeneous protocols into a standardized message format. The system caches the converted data in an in-memory database to enable real-time query processing. The generative AI scenario simulation unit has a hybrid architecture combining a deep reinforcement learning algorithm and a large language model. The simulation unit constructs a digital twin environment of a city on a memory, and executes millions of agent-based simulations in a virtual space. Input data to the artificial intelligence model is, for example, voxel data indicating a three-dimensional spatial model of a city, a tensor indicating a real-time traffic volume at each intersection, and a multidimensional array of weather forecast data. Output data from the artificial intelligence model is, for example, a scalar value indicating energy consumption efficiency of the entire city, a spatial heat map matrix indicating an occurrence probability of traffic congestion, and a sequence of optimal city control commands. The city management visualization and interpretation unit renders these output data using a three-dimensional graphics engine, and superimposes and displays information on a three-dimensional model of the city. In this rendering processing, the system generates a realistic visual representation using a ray tracing technology. As a technical effect, the system highly integrates a cyber space and a physical space, thereby grasping complex dynamics of a city in real time and predicting a future state with high accuracy. By utilizing an inference capability of a generative artificial intelligence, the system automatically creates a novel and optimal city management measure that a human city planner cannot assume. With a distributed processing architecture, the system suppresses a processing delay for petabyte-class city data to a millisecond unit, enabling an immediate response in an emergency. As a specific application field, the system can be applied to wide-area traffic control in a huge megalopolis and a wide-area evacuation guidance system in the event of a disaster. The system can also be applied to a microgrid management system that optimizes local production for local consumption of renewable energy in an environmentally advanced city. The system realizes sustainable and resilient city management in areas supporting the foundation of these urban infrastructures.

The city data integration unit has a function of automatically and continuously collecting data from various data sources inside and outside the city and aggregating the data into an integrated database. For example, as traffic volume data, real-time traffic sensors at major intersections and arterial roads, GPS data of vehicles, parking lot usage statuses, road construction and accident information, traffic light operation statuses, road regulation information, traffic congestion prediction data, and the like are acquired via an API or an IoT gateway. For example, as energy consumption data, power/gas/water consumption in each area, a renewable energy power generation amount, a storage battery remaining amount, a supply and demand balance at a peak time, an energy price, energy supply failure information, real-time data from a smart meter, and the like are acquired from an energy management system or an external database. For example, as environmental sensor data, temperature, humidity, precipitation, wind speed, PM2.5 and CO2 concentrations, a noise level, a river water level, soil moisture, an ultraviolet ray amount, a radiation dose, a pollen scattering amount, and the like are collected in real time from various sensors. For example, as public transportation operation data, operation schedules of buses and railways, delay information, the number of passengers, a congestion degree, operation route change information, operation suspension information, usage statuses of bus stops and stations, operation statuses of on-demand transportation, and the like are acquired from systems of transportation operators and open data. For example, as resident behavior logs, anonymized human flow data from smartphone applications, beacons, and Wi-Fi access points, facility usage histories, event participation histories, entry/exit records of commercial facilities and public facilities, mobile payment histories, movement patterns of tourists, and the like are collected. For example, as SNS data, posts are collected using keywords such as a city name, an event name, a disaster name, a traffic obstacle name, and a meteorological phenomenon name, and sentiment analysis, topic extraction, geographical distribution of posts, time-series changes in posting frequency, contents of remarks by influencers, and the like are analyzed. For example, as disaster information, disaster flashes from the Meteorological Agency and local governments, evacuation instructions, damage status reports, dispatch records of fire departments and police, occurrence information of earthquakes, typhoons, heavy rains, floods, sediment disasters, fires, power outages, water outages, communication failures, and the like, opening and accommodation statuses of shelters, traffic regulation information in the event of a disaster, and the like are acquired in real time. For example, as economic indicators, consumption trends by region, employment statistics, real estate prices, the number of tourists, sales of commercial facilities, a circulation amount of local currency, an unemployment rate, a price index, production output by industry, and the like are acquired from a statistical database or an economic information service. Specifically, the city data integration unit adopts a hierarchical data collection architecture composed of edge computing nodes and a cloud server. In each edge node, the system converts an analog signal output from a sensor into digital data, and executes initial filtering processing. The system asynchronously transmits the filtered data to the integrated database on the cloud using a publish-subscribe messaging protocol. The system applies a Kalman filter to a positioning coordinate array of a vehicle acquired as traffic volume data, and calculates an accurate trajectory vector in which a GPS positioning error is corrected. The system performs wavelet transform on multidimensional time-series data acquired from an environmental sensor, and performs feature extraction in a frequency domain. The system applies a pre-trained transformer model to text data of social media, and scores emotional polarity of each post as a continuous value from minus one to plus one. Input data to the artificial intelligence model is, for example, a high-resolution image tensor acquired from a camera installed at an intersection, and a one-dimensional array of power consumption transmitted from a smart meter at one-minute intervals. Output data from the artificial intelligence model is, for example, count data of an integer value indicating the number of vehicles and the number of pedestrians in an image, and a floating-point numerical value indicating a predicted value of power demand in the next one hour. The system converts these various formats of data into a multidimensional tensor structure having a common spatiotemporal index, and stores the data in a distributed relational database and a graph database. Using the graph database, the system models a complex relationship between different data domains, such as “congestion at a specific intersection” and “sales decline of surrounding commercial facilities”, as a network structure of nodes and edges. As a technical effect, the system provides an ability to grasp a situation of the entire city comprehensively and in real time by integrating siloed data scattered in the city into a single platform. By preprocessing on the edge side, the system significantly saves a communication bandwidth to the cloud and prevents network congestion. By utilizing the graph database, the system searches for a hidden causal relationship between multivariates at high speed, and constructs a basis for precise simulation. As a specific application field, the system can be applied to a base system of an integrated operation center of a smart city in a local government. The system can also be applied to a situation grasping and resource allocation optimization system at the time of occurrence of an incident in an emergency response agency such as police or fire department. The system realizes data-driven proactive city management in these public services.

The city data integration unit executes preprocessing on these data, such as data format conversion (for example, unification of CSV, JSON, XML, RDF, etc.), timestamp unification (for example, UTC conversion, local time correction, daylight saving time support), deletion of duplicate data (for example, deduplication by a primary key, merging of similar records), imputation of missing values (for example, previous value imputation, average value imputation, external reference value imputation, estimated imputation by machine learning), detection and removal of abnormal values (for example, sensor abnormality and outlier detection, 3-sigma method, IQR method, supervised anomaly detection model), standardization of numerical data (for example, Z-score standardization, min-max normalization, logarithmic transformation), smoothing and moving average of time-series data, geocoding of geographic information (for example, conversion from an address to latitude and longitude, mapping to a map tile), area classification by clustering (for example, K-means method, hierarchical clustering, DBSCAN, etc.), TF-IDF vectorization and embedding representation of text data, feature extraction of image data (for example, object detection by CNN), and frame analysis of video data, to generate a structured dataset suitable for city management analysis. For example, traffic volume data and public transportation data are integrated in time series to calculate a congestion degree transition and an abnormality occurrence timing for each specific area. For example, energy consumption data and weather data are combined to analyze a change in power demand and a supply and demand tightness risk due to temperature fluctuation or sudden weather change. For example, SNS data and disaster information are linked to grasp an expansion status of citizens' anxiety and confusion, a diffusion status of false rumor information, and shelter congestion in real time in the event of a disaster. For example, resident behavior logs and event information are combined to extract a human flow pattern, a congestion occurrence location, and an optimization point of security allocation during an event. Specifically, the city data integration unit defines a series of these preprocessing tasks as a dependency graph using a data pipeline orchestration tool, and automatically executes them. In the imputation of missing values, the system executes an advanced data imputation algorithm using a generative adversarial network. This algorithm repeats a process in which a generator infers data of a missing part and a discriminator determines whether it is real data or inferred data, thereby generating extremely natural imputed data. In the detection of abnormal values, the system applies an isolation forest algorithm to specify an observation value isolated from other data points in a multidimensional space at high speed. In the feature extraction of image data, the system uses a deep convolutional neural network having a residual connection. This network hierarchically extracts from low-order features such as edges and textures to high-order semantic features such as vehicles and pedestrians from an input image. Input data to the artificial intelligence model is, for example, a video frame tensor of full high-definition resolution acquired from a surveillance camera at an intersection, and character string data of a text post on social media. Output data from the artificial intelligence model is, for example, a list of bounding box coordinates and class labels of each object in a video frame, and a one-hot vector indicating topic classification of a text post. In the geocoding of geographic information, the system constructs a spatial index tree, and converts latitude and longitude coordinates into a hexagonal spatial grid ID having a specific resolution at high speed. Using this spatial grid ID as a primary key, the system spatially combines data of different domains such as traffic volume data, weather data, and human flow data. The system applies a tensor decomposition method to the combined data to extract a spatiotemporal latent pattern. As a technical effect, the system converts noisy and incomplete raw city data into a high-quality and high-dimensional structured tensor that can be directly processed by a machine learning model. By imputation of missing values using a generative adversarial network, the system minimizes an adverse effect of data loss due to a sensor failure or a communication error on simulation accuracy. By combining data using a spatial grid, the system dramatically reduces a calculation order of a complex spatial operation, enabling real-time cross-domain analysis. As a specific application field, the system can be applied to traffic impact evaluation and environmental assessment work of a redevelopment area in a city planning consultant. The system can also be applied to a dynamic inventory management and delivery planning system linked to weather and event information in a retail chain. The system supports construction of a precise prediction model considering various external factors in these fields.

The generative AI scenario simulation unit has a function of receiving the structured dataset generated by the city data integration unit and a city management scenario prompt input in a natural language by a user, and multidimensionally simulating a plurality of scenarios related to city management using a generative AI. For example, in response to a prompt “simulate an optimal evacuation guidance plan for residents in the event of a large-scale earthquake”, the unit comprehensively analyzes an earthquake occurrence point, building damage prediction, road passability, shelter capacity, resident distribution, past evacuation behavior data, confusion information on SNS, barrier-free support status of shelters, operation status of medical institutions, traffic regulation information in the event of a disaster, and the like, and outputs an optimal evacuation plan in real time regarding how many people should be guided to which shelter via which route. For example, in response to a prompt “propose signal control and public transportation operation optimization to minimize traffic congestion on weekday mornings”, the unit proposes a signal control optimization plan, a bus increase plan, a detour route recommendation plan, a traffic guide allocation plan, and the like based on a congestion degree of traffic sensors, an operation status of public transportation, a signal control pattern, past congestion occurrence factors, event holding information, road construction/accident information, weather information, school zone commuting time zone data, and the like. For example, in response to a prompt “simulate a measure to optimize a power supply and demand balance at a summer peak”, the unit simulates a peak shift measure, a power saving request timing, a storage battery discharge plan, a power saving target plan by industry, and the like based on a consumption peak of each area, a renewable energy power generation amount, a storage battery remaining amount, weather forecast, past supply and demand balance data, a power saving request history, a consumption pattern by industry, power accommodation possible area information, and the like. For example, in response to a prompt “simulate human flow dispersion and congestion mitigation measures during a large-scale event”, the unit proposes an admission restriction timing, a guidance route, a security allocation plan, a congestion warning transmission timing, and the like based on human flow data around an event venue, a congestion degree of public transportation, congestion reports on SNS, human flow patterns during past events, a security guard allocation history, an opening/closing history of admission gates, a congestion degree of toilets and shops, traffic regulation information of surrounding roads, and the like. Specifically, the scenario simulation unit analyzes the input natural language prompt, and mathematically formulates an objective function and a constraint condition of the simulation. The system applies a hybrid model combining a graph neural network and deep reinforcement learning to the formulated problem. The graph neural network expresses a road network and a power network of a city as a graph structure of nodes and edges, and learns spatial dependency by aggregating a feature amount of each node with neighboring nodes. The deep reinforcement learning agent receives this graph representation as a state space, and learns an optimal policy function through trial and error based on a Markov decision process. Input data to the artificial intelligence model is, for example, a vector indicating a current average vehicle speed of each road link, a scalar array indicating a current capacity of each shelter, and a one-hot encoding vector indicating an objective of “congestion minimization” extracted from the prompt. Output data from the artificial intelligence model is, for example, a control vector of a continuous value indicating a green time of a traffic light at each intersection, an integer matrix indicating the recommended number of guided people to each shelter, and a timestamp array indicating an execution timing of each measure. In the evacuation guidance simulation, the system calculates crowd dynamics in which tens of thousands of resident agents take evacuation actions while influencing each other using multi-agent reinforcement learning. In the signal control optimization, the system globally searches for an optimal solution of a signal offset in a wide-area road network using an evolutionary algorithm. In the power supply and demand optimization, the system calls a mixed integer linear programming solver, and calculates a strict optimal operation schedule satisfying a start/stop constraint of a generator and a transmission capacity constraint. As a technical effect, the system derives an optimal solution in real time for a complex city system that changes non-linearly and dynamically, which cannot be handled by conventional rule-based control. By using the graph neural network, the system acquires generalization performance to immediately adapt to a topology change of a city (for example, road disconnection due to an earthquake) without re-learning the model. By simulation using deep reinforcement learning, the system discovers an innovative city control pattern exceeding human rules of thumb. As a specific application field, the system can be applied to a damage assumption and resource allocation simulator in the event of a wide-area disaster in a national-level disaster prevention agency. The system can also be applied to an integrated operation system that realizes securing safety of spectators and smooth transportation in an organizing committee of an international sports tournament. The system enables scientific decision-making based on data in these extremely complex and mission-critical situations.

For each of these scenarios, the generative AI outputs an effect prediction of a measure plan, a risk evaluation, basis data, a comparison with past cases, a comparison of a plurality of plans, re-simulation when a scenario condition is changed, optimization of a cooperative measure of a plurality of departments, a balance evaluation of cost, effect, and risk, and the like as a natural language and numerical data. For example, specific proposals are obtained, such as “recommend distributed guidance to shelter B because shelter A may exceed its capacity”, “when signal control pattern X is applied, a congestion occurrence rate is reduced by 20%”, “an optimal timing to transmit a power saving request at a power peak is 15:00”, “strengthen guidance to a south exit because a congestion degree at a north exit of an event venue is approaching a past maximum value”, “recommend information transmission by a drone in a communication failure occurrence area in the event of a disaster”, and “propose installation of a mist shower and expansion of a first-aid station in an area with a high heatstroke risk”. Furthermore, when an additional prompt such as “explain a basis for this risk factor”, “propose an optimal measure plan”, “compare effects and costs of measure A and measure B”, or “recalculate a guidance plan considering a barrier-free support status of shelter C” is input from the user, the generative AI explains in a natural language which data or logic is used as a basis for determination, generates a plurality of measure plans, and explains in detail an expected effect, a risk, a cost, feasibility, a comparison with past success/failure cases, and the like of each plan. Specifically, the generative artificial intelligence receives a numerical optimal solution tensor output from the simulation engine, and maps it to a context of a natural language. In this mapping processing, the system adopts chain-of-thought prompting, which is a prompt engineering technology of a large language model. The system explicitly causes the model to generate an intermediate inference step, thereby enhancing logical validity of a final proposal. In order to optimize a cooperative measure of a plurality of departments, the system introduces a framework of a cooperative game based on game theory, and calculates a Pareto optimal solution that maximizes a payoff function of each department. Input data to the artificial intelligence model is, for example, a floating-point array indicating a cost of each measure obtained by simulation, a multidimensional matrix of an expected effect indicator, and a text token sequence of an additional question from the user. Output data from the artificial intelligence model is, for example, table data in a markdown format comparing cost-effectiveness of measure A and measure B, a database reference ID of past similar disaster data serving as a basis for a risk factor, and a spatial coordinate array of a recalculated evacuation guidance route. In response to a request “explain a basis” from the user, the system analyzes an attention map inside the model, and specifies an input feature amount that contributed most to output generation. The system extracts the specified feature amount (for example, precipitation data in a specific time zone or congestion degree data at a specific intersection), and incorporates it into an explanatory text in a natural language. In response to a recalculation request, the system immediately updates a changed constraint condition (for example, a barrier-free support status of shelter C) as an input parameter of the simulation engine, and re-executes it at high speed on an in-memory database. As a technical effect, the system presents an output result of an advanced mathematical model as a story in a natural language understandable even by a decision-maker without specialized knowledge, thereby improving an execution rate of an action based on data. By chain-of-thought prompting and attention analysis, the system makes an inference process of the artificial intelligence transparent, and ensures user's reliability on the output. With an immediate recalculation function through an interactive interface, the system enables an agile response to an ever-changing city situation. As a specific application field, the system can be applied to a decision-making support dashboard used by a head of a local government or a crisis management director at a disaster response headquarters. The system can also be applied to a joint simulation platform for a plurality of infrastructure operators (power, transportation, communication, etc.) to cooperate and improve resilience of a city. The system logically and quickly guides policy decision-making involving a complex trade-off in these use cases.

The city management visualization and interpretation unit has a function of displaying a measure plan, an effect prediction, a risk evaluation, and the like for each scenario output by the generative AI as an evacuation route display on a map, a congestion degree heat map, a time-series graph, an effect comparison chart for each measure plan, a contribution degree graph of a risk factor, a scenario branch tree, a spatiotemporal change display of human flow, traffic, and energy consumption by animation, a real-time display of warnings and advisories, a hyperlink to basis data, an explanatory text of a determination basis and a thinking process of the AI, and the like on a dashboard. For example, in an evacuation guidance scenario, an evacuation route and an accommodation status of a shelter are color-coded and displayed on a map, a route or a shelter with a high congestion degree is displayed as a warning, and a barrier-free support status and a medical system for each shelter are also displayed as icons. For example, in a traffic congestion mitigation scenario, a congestion degree heat map for each major intersection, a congestion occurrence rate graph for each signal control pattern, a time-series transition of a bus increase effect, and an optimization map of traffic guide allocation are displayed. For example, in an energy supply and demand optimization scenario, a consumption peak time and a power saving request timing of each area are shown by a time-series graph, a supply and demand balance improvement effect for each measure plan is displayed by a comparison chart, and effect verification of a power saving request and an achievement status of a power saving target by industry are also visualized. For example, in a human flow control scenario during an event, a human flow distribution around a venue is animated and displayed on a map, and a security allocation, an optimization plan of a guidance route, a congestion warning transmission timing, a congestion degree of toilets and shops, an installation location of a first-aid station, and the like are visualized. Specifically, the city management visualization and interpretation unit includes a geographic information system engine, and renders multidimensional spatial data at high speed. Using a vector tile technology, the system dynamically adjusts a drawing detail level of a map according to a zoom level, and reduces a drawing load on a client terminal. In the animation display of a spatiotemporal change, the system executes interpolation calculation of data along a time axis in parallel on a shader program of a graphics processing unit, and realizes smooth drawing at 60 frames per second. In drawing a scenario branch tree, the system applies a layout algorithm of a directed acyclic graph, and visually organizes and arranges complex conditional branches. Input data to the artificial intelligence model is, for example, an array of latitude and longitude coordinates of each evacuation route, a normalized scalar value from zero to one hundred indicating a congestion degree of each intersection, and a multidimensional vector indicating an expected effect of each measure. Output data from the artificial intelligence model is, for example, polygon data for overlay display on a map, an array of RGB values defining a color gradation of a heat map, and structured data in a JSON format for graph drawing. The system push-distributes these drawing data to a client terminal in real time using WebSocket communication. When a user clicks a specific icon on a map, the system asynchronously loads and displays detailed basis data related to the element and an inference process of the artificial intelligence as a pop-up window. As a technical effect, the system converts huge and complex dynamics data of a city into intuitive visual information, thereby maximizing a situation awareness capability of an operator. With high-speed rendering utilizing a graphics processing unit and a vector tile technology, the system provides smooth operability without delay even for wide-area city data. By seamless linkage between a visual alert and basis data, the system shortens a cognitive process from abnormality detection to cause investigation and countermeasure planning. As a specific application field, the system can be applied to a real-time traffic flow monitoring and signal control console in a traffic control center of police. The system can also be applied to a flow line analysis of visitors and a staff allocation optimization dashboard in a large-scale theme park. The system supports quick and accurate command and control for an ever-changing situation at these sites.

Furthermore, the city management visualization and interpretation unit automatically creates a report of a current status analysis, issue extraction, a specific measure plan, an expected effect, a risk factor and a countermeasure thereof, a balance evaluation of cost, effect, and risk, necessity of multi-department cooperation, an implementation schedule plan, an emergency response flow, and the like based on a simulation result, and enables a city management personnel to view and share the report in PDF or HTML. For example, report contents can be automatically customized according to an application or a user attribute, such as an evacuation plan report for a disaster response headquarters, a congestion mitigation measure report for a traffic control center, a supply and demand optimization report for an energy supplier, a human flow control report for an event organizer, an environmental load reduction measure report for an environmental department, and a future prediction scenario report for a city planning department. Specifically, the city management visualization and interpretation unit activates a dedicated natural language processing pipeline for report generation. The system integrates numerical data of a simulation result, generated text, and a rendered graph image on a memory. The system acquires profile data indicating an affiliated department and a job title of a user from a database. Based on this profile data, the system executes a rule-based inference engine that determines components of a report, a level of specialized knowledge, and a key performance indicator to be emphasized. In accordance with the determined configuration, the system transmits a prompt to a large language model to generate text of each section. Input data to the artificial intelligence model is, for example, a multidimensional tensor indicating a final result of simulation, a categorical variable indicating an attribute of a target user, and a text token sequence indicating an objective of a report. Output data from the artificial intelligence model is, for example, a summary text of a current status analysis, structured data for drawing a Gantt chart indicating an implementation schedule of a measure, and a flowchart definition character string indicating an emergency response flow. The system pours the output text and structured data into a pre-designed cascading style sheet template. The system executes a headless browser in the background, renders the generated hypertext markup language document, and converts it into a high-resolution portable document format file. The system adds an electronic signature to the generated report to prevent falsification. As a technical effect, the system automatically translates a complex simulation result into a format tailored to interests of each stakeholder, thereby significantly reducing a communication cost between organizations. By programmatically generating a rich document including a graph image and a flowchart, the system reduces time for manual material creation to zero. By ensuring authenticity with an electronic signature, the system enables use as an official record document in a public institution. As a specific application field, the system can be applied to automatic creation of a city planning assessment report to be distributed at a city council or a resident briefing session. The system can also be applied to a joint report creation work of a damage status and a recovery plan in the event of a disaster for the purpose of information sharing among infrastructure operators. The system realizes quick and accurate information disclosure and promotes consensus building among stakeholders in these use cases.

In addition, when a user changes a scenario condition or a measure plan on a dashboard, for example, when a capacity of a shelter is increased, when a signal control pattern is changed, when a timing of a power saving request is moved forward, or when the number of admission gates of an event venue is increased, the changed content can be immediately re-prompted to the generative AI, a re-simulation result can be re-displayed in real time as a map, a graph, a chart, and an explanatory text, and the content can be automatically created as a report and output in a PDF or HTML format. Furthermore, it can be applied to broader city management optimization, such as simultaneous operation in a plurality of cities or wide-area local governments, optimization of an inter-city cooperation scenario, a wide-area evacuation plan in the event of a disaster, an inter-city energy accommodation scenario, and inter-city human flow control at the time of tourist influx. Specifically, a user interface unit of the system detects a parameter change input from a user. The user interface unit converts the changed parameter into a numerical vector. The system combines this numerical vector with an existing prompt embedding vector. The system supplies the combined vector to a generative AI model as a new input tensor. The generative AI model is a large language model based on a transformer architecture. The generative AI model receives the input tensor. The generative AI model recalculates an impact of the changed parameter on dynamics of the entire city using a self-attention mechanism. The generative AI model outputs a recalculation result. This output data includes a score of a floating-point number indicating a success probability of each measure. This output data includes time-series array data indicating predicted traffic volume and energy consumption. This output data includes a token sequence of a natural language explaining a basis of a measure. A rendering engine of the system receives these output data. The rendering engine converts the time-series array data into coordinate data for graph drawing. The rendering engine decodes the token sequence of a natural language into text data. The rendering engine redraws these data on the dashboard. A report generation unit of the system captures the redrawn screen components. The report generation unit arranges the captured components in a predetermined template. The report generation unit encodes the arrangement result as a file in a PDF format or an HTML format. The report generation unit saves the generated file in a storage. The system supports simultaneous operation in a plurality of cities. The system includes an edge server that processes data of each city, and a cloud server that supervises the whole. The cloud server collects an intermediate representation vector from each edge server. The cloud server learns a wide-area optimization model using a federated learning method. The cloud server distributes a weight parameter of the learned model to each edge server. With this distributed processing architecture, the system distributes a calculation load. The system suppresses an explosive increase in a calculation amount in wide-area optimization. The system improves simulation accuracy of an inter-city cooperation scenario while protecting data privacy between cities. The system searches for an optimal solution in a high-dimensional parameter space at a speed impossible by human intuition or manual recalculation. The system eliminates a delay in decision-making in city management. The system realizes a quick response and optimal allocation of resources in the event of a disaster.

As described above, in the embodiment of the present invention, the city data integration unit integrates and preprocesses various city data in real time, the generative AI scenario simulation unit multidimensionally simulates complex and various scenarios related to city management, and the city management visualization and interpretation unit provides the result intuitively and with a basis by various visualization means and automatic report generation, thereby enabling a city management personnel to make a quick and highly convincing decision, and dramatically improving safety, efficiency, comfort, and sustainability of a city. Specifically, the system maps heterogeneous city data to a common high-dimensional vector space. The city data integration unit inputs data of different modalities such as text, image, and numerical sensor data to respective dedicated encoders. The city data integration unit combines feature vectors output from the respective encoders. The city data integration unit transmits the combined feature vector to the generative AI scenario simulation unit. The generative AI scenario simulation unit processes the feature vector using a deep neural network. The generative AI scenario simulation unit has an architecture combining a multilayer perceptron and an attention layer. The generative AI scenario simulation unit calculates a non-linear interaction between the input feature vectors. The generative AI scenario simulation unit quantifies an influence that each element of a city exerts on each other. The generative AI scenario simulation unit outputs a prediction tensor indicating a future city state as a simulation result. The city management visualization and interpretation unit receives this prediction tensor. The city management visualization and interpretation unit converts the prediction tensor into a format visually understandable by a human. The city management visualization and interpretation unit extracts an attention weight from an internal state of the neural network. The city management visualization and interpretation unit modulates a color and transparency of a display element according to a magnitude of the attention weight. The system executes these processes in real time by parallel calculation using a graphics processing unit. The system simultaneously optimizes a huge number of variables that cannot be processed by a human mental process. The system generates a solution to an unknown city issue by a data-driven approach without depending on specific rule-based processing. The system maximizes operation efficiency of an urban infrastructure. The system reduces waste of energy consumption. The system automatically generates a specific action plan for minimizing damage in the event of a disaster. The system brings about a technical effect of optimizing control of a physical urban space by applying a data processing capability of a computer technology itself.

### (System Configuration)

A system according to the present embodiment comprises a city data integration unit, a generative AI scenario simulation unit, a city management visualization and interpretation unit, a user interface unit, and a report generation unit. The city data integration unit has a function of automatically collecting various data related to city management in real time and aggregating the data into an integrated database. For example, as traffic volume data, real-time traffic sensors of major intersections and arterial roads, GPS data of vehicles, parking lot usage statuses, road construction and accident information, traffic light operation statuses, road regulation information, traffic congestion prediction data, and the like are acquired via an API or an IoT gateway, as energy consumption data, power, gas, and water consumption amounts of each area, a renewable energy power generation amount, a storage battery remaining amount, a supply and demand balance at a peak time, an energy price, energy supply failure information, real-time data from a smart meter, and the like are acquired from an energy management system or an external database, as environmental sensor data, temperature, humidity, precipitation, wind speed, PM2.5 and CO2 concentrations, a noise level, a river water level, soil moisture, an ultraviolet ray amount, a radiation dose, a pollen scattering amount, and the like are collected in real time from various sensors, as public transportation operation data, operation schedules of buses and railways, delay information, the number of passengers, a congestion degree, operation route change information, operation suspension information, usage statuses of bus stops and stations, operation statuses of on-demand transportation, and the like are acquired from systems of transportation operators or open data, as resident behavior logs, anonymized human flow data from smartphone applications, beacons, and Wi-Fi access points, facility usage histories, event participation histories, entry and exit records of commercial facilities and public facilities, mobile payment histories, movement patterns of tourists, and the like are collected, as social media data, posts are collected using keywords such as a city name, an event name, a disaster name, a traffic obstacle name, and a meteorological phenomenon name, and sentiment analysis, topic extraction, geographical distribution of posts, time-series changes in posting frequency, utterance contents of influencers, and the like are analyzed, as disaster information, disaster flashes of the Meteorological Agency and local governments, evacuation instructions, damage status reports, dispatch records of fire departments and police, occurrence information of earthquakes, typhoons, heavy rains, floods, landslide disasters, fires, power outages, water outages, communication failures, and the like, opening and accommodation statuses of shelters, traffic regulation information in the event of a disaster, and the like are acquired in real time, and as economic indicators, consumption trends for each area, employment statistics, real estate prices, the number of tourists, sales of commercial facilities, a circulation amount of local currency, an unemployment rate, a price index, production output by industry, and the like are acquired from a statistical database or an economic information service. The city data integration unit performs preprocessing such as data format conversion, timestamp unification, deletion of duplicate data, imputation of missing values, detection and removal of abnormal values, standardization of numerical data, smoothing and moving average of time-series data, geocoding of geographic information, area classification by clustering, TF-IDF vectorization and embedding representation of text data, feature extraction of image data, and frame analysis of video data on these data to generate a structured dataset suitable for city management analysis. Specifically, the city data integration unit of the present system comprises a data collection module supporting a plurality of asynchronous communication protocols. The data collection module receives streaming data from each sensor or external system. The city data integration unit temporarily stores the received data in an in-memory database. The city data integration unit uses a deep learning model based on an autoencoder in the imputation processing of missing values. The autoencoder has learned normal data patterns, and reconstructs a complete data vector from an input vector including a missing part. The city data integration unit executes an isolation forest algorithm in the detection processing of abnormal values. The algorithm randomly divides data points, and calculates an anomaly score based on the number of divisions until isolation. The city data integration unit removes a data point whose anomaly score exceeds a predetermined threshold as noise. The city data integration unit utilizes a pre-trained language model in the processing of text data. The language model converts the input text into a 768-dimensional dense embedding vector. The city data integration unit utilizes a convolutional neural network in the processing of image data. The convolutional neural network extracts spatial features from the input image, and outputs a multidimensional feature map tensor. The city data integration unit combines these preprocessed data to generate a structured dataset in a unified format. The structured dataset is held in a memory as graph-structured data in which nodes represent respective elements of the city and edges represent relationships between the elements. The present system significantly improves a learning convergence speed of a subsequent generative AI model by this advanced data preprocessing pipeline. The present system reduces an inference error caused by noise or missing. The present system realizes an improvement in computer technology for uniformly handling heterogeneous mixed data. The present system functions as an integrated data infrastructure in a smart city.

The generative AI scenario simulation unit has a function of receiving the structured dataset generated by the city data integration unit and a city management scenario prompt in a natural language input from the user interface unit, and multidimensionally simulating a plurality of scenarios related to city management using a generative AI. For example, prompt sentences such as “simulate an optimal evacuation guidance plan for residents in the event of a large-scale earthquake”, “propose signal control and public transportation operation optimization for minimizing traffic congestion on weekday mornings”, “simulate a measure for optimizing a power supply and demand balance at a summer peak”, “simulate human flow dispersion and congestion mitigation measures during a large-scale event”, “propose optimization of information transmission means in a communication failure occurrence area in the event of a disaster”, “simulate a countermeasure in an area with a high heatstroke risk”, “optimize inter-city human flow control during tourist influx”, and “analyze a CO2 emission reduction scenario of the entire city” are given as specific examples. The generative AI comprehensively analyzes various data related to city management such as an earthquake occurrence point, building damage prediction, road passability, shelter capacity, resident distribution, past evacuation behavior data, confusion information on social media, barrier-free support statuses of shelters, operation statuses of medical institutions, traffic regulation information in the event of a disaster, congestion degrees of traffic sensors, operation statuses of public transportation, signal control patterns, past congestion occurrence factors, event holding information, road construction and accident information, weather information, school commuting time zone data of school zones, an energy consumption peak, a renewable energy power generation amount, a storage battery remaining amount, weather prediction, a power saving request history, consumption patterns by industry, power interchangeable area information, human flow data around an event venue, security guard allocation histories, opening and closing histories of entrance gates, congestion degrees of toilets and shops, and installation locations of first-aid stations, and outputs an effect prediction of a measure plan, a risk evaluation, basis data, a comparison with past cases, a comparison of a plurality of plans, a re-simulation when a scenario condition is changed, optimization of a cooperative measure of a plurality of departments, a balance evaluation of cost, effect, and risk, and the like as a natural language and numerical data. Specifically, the generative AI scenario simulation unit adopts a hybrid architecture combining a graph neural network and a transformer model. The generative AI scenario simulation unit receives the graph-structured data from the city data integration unit. The graph-structured data is expressed as a third-order tensor having the number of nodes, a time step, and a feature dimension. The generative AI scenario simulation unit converts the natural language prompt from the user into an integer token ID sequence by a tokenizer. The generative AI scenario simulation unit inputs the token ID sequence to a word embedding layer to generate a prompt feature vector. The generative AI scenario simulation unit extracts a spatial dependency relationship from the graph-structured data using the graph neural network. The generative AI scenario simulation unit extracts a temporal dependency relationship using the transformer model. The generative AI scenario simulation unit fuses the prompt feature vector and the extracted spatiotemporal feature vector using a cross-attention mechanism. The generative AI scenario simulation unit inputs the fused vector to a plurality of prediction heads. The prediction head outputs a continuous value score from 0.0 to 1.0 indicating a success probability of the measure plan. The prediction head outputs a categorical probability distribution for classifying a risk factor. The prediction head autoregressively generates a natural language token sequence describing specific contents of the measure. The present system filters only a measure plan whose output success probability score exceeds a predetermined threshold. The present system transmits the filtered measure plan to a subsequent visualization processing module. The present system simultaneously models a physical spatial structure and a temporal change of the city by this hybrid architecture. The present system simulates a complex causal relationship that is difficult to predict with a simple statistical model with high accuracy. The present system effectively utilizes calculation resources and shortens an execution time of the simulation. The present system supports scientific decision-making based on data in a wide range of fields such as traffic control, energy management, and disaster prevention planning.

The city management visualization and interpretation unit has a function of displaying the measure plan, the effect prediction, the risk evaluation, and the like for each scenario output by the generative AI as an evacuation route display on a map, a congestion degree heat map, a time-series graph, an effect comparison chart for each measure plan, a contribution degree graph of a risk factor, a scenario branch tree, a spatiotemporal change display of human flow, traffic, and energy consumption by animation, a real-time display of warnings and advisories, a hyperlink to basis data, an explanatory text of a determination basis and a thinking process of the AI, and the like on a dashboard. For example, in the evacuation guidance scenario, an evacuation route and an accommodation status of a shelter are color-coded and displayed on a map, a route or a shelter with a high congestion degree is displayed as a warning, and a barrier-free support status and a medical system for each shelter are also displayed as icons. For example, in the traffic congestion mitigation scenario, a congestion degree heat map for each major intersection, a congestion occurrence rate graph for each signal control pattern, a time-series transition of a bus increase effect, and an optimization map of traffic guide allocation are displayed. For example, in the energy supply and demand optimization scenario, a consumption peak time and a power saving request timing of each area are shown by a time-series graph, a supply and demand balance improvement effect for each measure plan is displayed by a comparison chart, and effect verification of a power saving request and an achievement status of a power saving target by industry are also visualized. For example, in the human flow control scenario during an event, a human flow distribution around a venue is animated and displayed on a map, and an optimization plan for security allocation and a guidance route, a congestion warning transmission timing, congestion degrees of toilets and shops, installation locations of first-aid stations, and the like are visualized. Specifically, the city management visualization and interpretation unit comprises a rendering pipeline by hardware acceleration using a graphics processing unit. The city management visualization and interpretation unit receives the tensor data and the structured data output from the generative AI. The city management visualization and interpretation unit converts these data into primitive data including vertex coordinates, color information, and texture coordinates for drawing. The city management visualization and interpretation unit executes a feature attribution algorithm such as an integrated gradients method in order to visualize the determination basis of the AI model. The algorithm calculates a gradient of each input feature amount with respect to an output predicted value, and calculates an influence degree score. The city management visualization and interpretation unit maps the calculated influence degree score to a color map having a gradation from blue to red. The city management visualization and interpretation unit superimposes and draws this color map on map data as a heat map. The city management visualization and interpretation unit smoothly interpolates data between discrete time steps using a spline interpolation algorithm in the animation display of the spatiotemporal change. The city management visualization and interpretation unit outputs the interpolated frame data to a display at a high frame rate. The present system eliminates a black box nature of the AI model by these advanced visualization processes. The present system enables the user to intuitively verify validity of a simulation result. The present system significantly reduces a cognitive load of the user by visually organizing complex multidimensional data. The present system minimizes an update latency of a screen including a large amount of data points by optimizing drawing processing. The present system strongly supports real-time situation grasping and rapid command control in a city monitoring center or a disaster response headquarters.

The user interface unit provides an interface in a chat format in which a city management personnel can input a scenario, an analysis condition, an additional question, a change instruction of a measure plan, and the like in a natural language, and enables the visualization result and the report to be viewed on the dashboard. For example, instructions such as “recalculate an evacuation guidance plan when shelter capacity is enhanced”, “re-simulate a congestion occurrence rate when a signal control pattern is changed”, “re-evaluate a supply and demand balance when a timing of a power saving request is advanced”, and “re-predict a congestion degree when the number of entrance gates of an event venue is increased” are received, re-analysis and report re-generation are performed on the server side, and a result is returned to a terminal in real time. Specifically, the user interface unit comprises a dedicated natural language processing engine for analyzing the input natural language text. The engine includes a pre-trained transformer-type neural network. The network divides the input text into subword units to generate a token sequence. The network converts each token into a high-dimensional embedding vector. The network calculates a dependency relationship between tokens using a self-attention mechanism. The present system classifies an intention of the user based on this calculation result. The present system extracts a parameter necessary for the simulation from the classification result. For example, the present system extracts an identifier of a target shelter and numerical data indicating the number of accommodated persons after enhancement from the text “enhance shelter capacity”. The present system converts the extracted parameter into a structured data format. The present system transmits this structured data to a simulation execution unit. The present system triggers recalculation processing to the simulation execution unit. The present system sequentially transmits a progress status of the recalculation to the terminal using an asynchronous communication protocol. The present system receives an updated simulation result when the recalculation is completed. The present system binds the received result to a display component on the dashboard. The present system executes redrawing processing of a screen. With this configuration, the present system converts an ambiguous natural language input of the user into a strict computer command. The present system seamlessly connects an intuitive operation of a human and a strict numerical calculation of a computer. The present system eliminates the need for a complex parameter setting operation in a conventional graphical user interface. The present system significantly reduces an operation load of the city management personnel. The present system exhibits a technical effect of speeding up a decision-making process. The present technology can be applied to a field requiring a rapid operation such as an emergency response system in the event of a disaster or a traffic control system.

The report generation unit automatically creates a report of a current status analysis, issue extraction, a specific measure plan, an expected effect, a risk factor and a countermeasure thereof, a balance evaluation of cost, effect, and risk, necessity of multi-department cooperation, an implementation schedule plan, an emergency response flow, and the like based on a simulation result, and enables the city management personnel to view and share the report in PDF or HTML. For example, report contents can be automatically customized according to an application or a user attribute, such as an evacuation plan report for a disaster response headquarters, a congestion mitigation measure report for a traffic control center, a supply and demand optimization report for an energy supplier, a human flow control report for an event organizer, an environmental load reduction measure report for an environmental department, and a future prediction scenario report for a city planning department. Specifically, the report generation unit implements a natural language generation pipeline using a large language model. The pipeline receives multidimensional tensor data and time-series array data obtained as the simulation result as an input. The present system embeds these numerical data into a prompt template in a text format. The present system acquires attribute data indicating an affiliated department and an authority level of the user. The present system determines a granularity of information to be output and a level of technical terms based on the attribute data. The present system inputs the determined condition to the large language model as a control prompt. The large language model analyzes contexts of the input numerical data and the control prompt. The large language model sequentially generates words by autoregressive probability distribution calculation. The large language model constructs a logical sentence structure from the current status analysis to the emergency response flow. The present system executes syntax analysis on the generated text data. The present system automatically corrects a grammatical error and a numerical contradiction. The present system converts the corrected text data into a markup language format. The present system embeds a graph image and a map image of the simulation result in the markup language. The present system activates a rendering engine. The rendering engine analyzes the markup language and calculates a page layout. The rendering engine generates a final portable document format file or hypertext markup language file. With this configuration, the present system instantaneously generates a structured document understandable by a human from a huge amount of numerical data. The present system dramatically reduces a time for data aggregation and material creation conventionally performed manually by a human. The present system exhibits a technical effect of uniforming quality of the report and eliminating a human error. The present technology can be applied to automatic creation of a regular report in an administrative agency, an emergency report distribution system when an incident occurs, and the like.

As described above, in the system according to the present embodiment, the city data integration unit, the generative AI scenario simulation unit, the city management visualization and interpretation unit, the user interface unit, and the report generation unit organically cooperate to integrate and analyze a huge amount of and various data related to city management in real time, integrally realize advanced scenario simulation utilizing a generative AI, intuitive visualization, basis explanation, an interactive operation, and automatic report generation, and enable the city management personnel to make a rapid and highly convincing decision. Specifically, the present system deploys each processing unit as an independent microservice on a containerized environment. The present system executes communication between respective containers using a high-speed remote procedure call protocol. The present system temporarily stores the streaming data collected by the data integration unit in an in-memory data grid. The present system shares data among respective processing units via this in-memory data grid. The present system offloads inference processing of a generative artificial intelligence model to a parallel calculation core of an image processor. The present system executes rendering processing of visualization data in a separate thread in parallel with the inference processing. The present system constantly monitors a load status of the entire system by a monitoring agent. The present system executes auto-scaling processing of automatically increasing the number of replicas of the container when the load exceeds a threshold. The present system completes a complex simulation for petabyte-class city data with low latency by this distributed processing architecture. The present system achieves both real-time performance and scalability, which have been difficult to realize with a conventional monolithic system architecture. The present system realizes an improvement in computer technology itself, which is optimal allocation of computer resources and maximization of processing throughput, rather than mere business efficiency improvement. Since each module is loosely coupled, the present system can add a new artificial intelligence model or data source without stopping the system. The present system exhibits a technical effect of dramatically improving availability and expandability of the system. The present technology can be applied to an integrated operation center of a smart city, a wide-area monitoring and control system of a large-scale infrastructure, and the like.

### Implementation Steps

Step 1: Collection and Integration of City Data

The city data integration unit automatically and continuously collects data from various data sources inside and outside the city such as traffic volume data, energy consumption data, environmental sensor data, public transportation operation data, resident behavior logs, social media data, disaster information, and economic indicators, and aggregates the data into an integrated database. For example, real-time traffic sensors of major intersections and arterial roads, GPS data of vehicles, parking lot usage statuses, road construction and accident information, power, gas, and water consumption amounts of each area, a renewable energy power generation amount, temperature, humidity, precipitation, PM2.5 and CO2 concentrations, operation schedules of buses and railways, the number of passengers, human flow data from smartphone applications and beacons, posts on social media, disaster flashes of the Meteorological Agency and local governments, consumption trends and employment statistics for each area, and the like are acquired in various formats. Specifically, the city data integration unit implements a distributed message queuing system. The present system asynchronously receives high-frequency streaming data transmitted from millions of Internet of Things sensors. The present system classifies the received data by topic and accumulates the data in a message broker. The present system comprises a dedicated adapter group for absorbing a communication protocol of each data source. The present system acquires data via various protocols such as a hypertext transfer protocol, a message queuing telemetry transport, and a file transfer protocol. The present system stores the acquired raw data in a temporary data lake. The present system executes schema verification on the data in the data lake. The present system automatically applies format conversion processing when detecting an inconsistency in data format. The present system assigns a spatial index to data including spatial information. The present system unifies a timestamp to coordinated universal time for data including time information. The present system stores the normalized data in a distributed relational database and a time-series database. The present system distributes data writing processing to a plurality of storage nodes. The present system maximizes writing throughput. With this configuration, the present system captures a huge heterogeneous mixed data stream in real time without missing. The present system provides a unified data access interface optimized for subsequent artificial intelligence processing. The present system exhibits a technical effect of eliminating a bottleneck of data collection and improving data processing efficiency of the entire system. The present technology can be applied to a data aggregation infrastructure of a wide-area sensor network, an integrated analysis platform of multimodal data, and the like.

Step 2: Data Preprocessing and Feature Extraction

The city data integration unit performs data format conversion, timestamp unification, deletion of duplicate data, imputation of missing values, detection and removal of abnormal values, standardization of numerical data, smoothing and moving average of time-series data, geocoding of geographic information, area classification by clustering, vectorization of text data, feature extraction of image data, and the like on the collected data to generate a structured dataset suitable for city management analysis. For example, traffic volume data and public transportation data are integrated in time series to calculate a congestion degree transition for each specific area, energy consumption data and weather data are combined to analyze a change in power demand, and social media data and disaster information are linked to grasp a confusion status of citizens in the event of a disaster. Specifically, the city data integration unit executes an advanced data preprocessing pipeline based on machine learning. The present system applies a deep learning model using an autoencoder instead of simple average value imputation in the imputation of missing values. The present system learns a latent feature of a missing part from surrounding spatiotemporal data, and generates and imputes a highly accurate estimated value. The present system executes an isolation forest algorithm or a one-class support vector machine in the detection of abnormal values. The present system calculates a distribution density of data in a multidimensional feature space, and automatically identifies and flags a statistical outlier. The present system generates a word embedding vector using a pre-trained language model for text data. The present system extracts a feature map of an image using a convolutional neural network and converts the feature map into a fixed-length vector for image data. The present system maps these heterogeneous data to the same latent space. The present system combines the data based on temporal and spatial proximity to construct multidimensional tensor data. The present system applies principal component analysis or t-distributed stochastic neighbor embedding to this tensor data. The present system performs dimensionality reduction to retain an important feature while reducing a calculation cost. With this configuration, the present system converts raw data in the real world containing a lot of noise and missing into high-quality structured data that can be directly processed by an artificial intelligence model. The present system eliminates data cleansing by human manual work. The present system exhibits a technical effect of realizing automation and accuracy improvement of preprocessing and significantly reducing an error of subsequent inference processing. The present technology can be applied to construction of a prediction model of a financial market, an integrated analysis system of medical data, and the like.

Step 3: User Scenario Input and Prompt Generation

Through a user interface unit, a city management personnel inputs a scenario, an analysis condition, an additional question, and the like in a natural language. For example, prompt sentences such as “simulate an optimal evacuation guidance plan for residents in the event of a large-scale earthquake”, “propose signal control and public transportation operation optimization to minimize traffic congestion on weekday mornings”, “simulate a measure to optimize a power supply and demand balance at a summer peak”, “simulate a human flow dispersion and congestion mitigation measure during a large-scale event”, “propose optimization of an information transmission means in a communication failure occurrence area in the event of a disaster”, and “simulate a countermeasure in an area with a high heatstroke risk” are specific examples. Specifically, the user interface unit includes a prompt engineering module configured to dynamically expand the input natural language text. The module receives a short text input by a user. The module extracts a keyword from the input text. The module searches an ontology database in the system using the extracted keyword as a key. The module acquires a related technical term, a constraint condition, and metadata of a past similar simulation. The module adds the acquired information to the original input text. The module maps this information to a structured prompt template that is easy for a large language model to understand. The system explicitly describes a format of input data, an expected output format, and an evaluation index in the prompt. For example, in response to an input of “optimal evacuation guidance plan”, the system automatically supplements a technical instruction of “objective function: minimization of evacuation completion time, constraint condition: maximum capacity of shelter, output format: graph structure data including the number of passing people of each node”. The system inputs the generated expanded prompt to a parser. The system verifies logical consistency of the prompt. When a contradiction is detected, the system displays a dialog prompting the user to re-input a parameter. With this configuration, the system converts an ambiguous instruction of a user without specialized knowledge into a strict calculation task definition that can be accurately executed by an artificial intelligence model. The system suppresses fluctuation in an output of a generative artificial intelligence depending on prompt quality. The system exhibits a technical effect of improving reproducibility and reliability of a simulation. The present technology can be applied to a natural language interface of a complex business system, an interactive data analysis platform, and the like.

Step 4: City Scenario Simulation by Generative AI

The generative AI scenario simulation unit inputs the prompt sentence and the structured dataset to a generative AI, and multidimensionally simulates a plurality of scenarios related to city management. For example, the generative AI scenario simulation unit comprehensively analyzes an earthquake occurrence point, a building damage prediction, road passability, a shelter capacity, a resident distribution, past evacuation behavior data, confusion information on an SNS, a congestion degree of a traffic sensor, an operation status of public transportation, a signal control pattern, an energy consumption peak, a weather forecast, human flow data around an event venue, and the like, and outputs an effect prediction of a measure plan, a risk evaluation, basis data, a comparison with past cases, a comparison of a plurality of plans, a re-simulation when a scenario condition is changed, and the like as a natural language and numerical data. Specifically, the generative AI scenario simulation unit executes a hybrid architecture integrating a graph neural network and a large language model. The system represents a road network and infrastructure facilities of a city as graph structure data composed of nodes and edges. The system assigns a multidimensional feature vector such as a population density, an earthquake resistance score of a building, and a current traffic volume to each node. The system inputs the graph structure data and the expanded prompt generated in the preceding stage to an artificial intelligence model. Input data to the artificial intelligence model is, for example, a graph tensor consisting of a node feature matrix having 10,000 nodes and 256 feature dimensions, and an adjacency matrix. The graph neural network executes a message passing algorithm. The network exchanges feature vectors between adjacent nodes to learn a spatial interaction. The network outputs a latent representation vector of each node. The system projects the latent representation vector into an input space of the large language model. The large language model combines the projected vector and a text embedding of the prompt. The large language model simultaneously processes a spatial feature and a text context using a self-attention mechanism of a transformer. The artificial intelligence model generates, as an output, a numerical vector indicating a predicted capacity of each shelter, a score array indicating a congestion probability of each road segment, and a natural language text explaining validity of a measure. The system inputs the output numerical vector to a threshold determination module. The system identifies a shelter whose capacity exceeds an upper limit, and sets an alert flag. With this configuration, the system realizes simultaneous analysis of unstructured data and a complex spatial network, which has been difficult with a conventional mathematical optimization model. The system elucidates a non-linear causal relationship in a high-dimensional space. The system exhibits a technical effect of dramatically improving prediction accuracy of a simulation. The present technology can be applied to an optimization simulation of a supply chain, a failure propagation prediction of a communication network, and the like.

Step 5: Visualization of Simulation Result and Presentation of Basis

The city management visualization and interpretation unit displays the measure plan, the effect prediction, the risk evaluation, and the like for each scenario output by the generative AI as an evacuation route display on a map, a congestion degree heat map, a time-series graph, an effect comparison chart for each measure plan, a contribution degree graph of a risk factor, a spatiotemporal change display of human flow, traffic, and energy consumption by animation, a real-time display of an alarm and an advisory, a hyperlink to basis data, an explanatory text of a determination basis and a thinking process of the AI, and the like on a dashboard. Specifically, the city management visualization and interpretation unit implements a high-performance rendering engine using a web graphics library. The system receives multidimensional simulation result data output by the generative artificial intelligence. The system converts array data including spatial coordinate data and a prediction score into a vertex buffer object that can be directly processed by a graphics processing unit. The system executes a fragment shader. The system dynamically calculates a pixel color according to a value of the prediction score to generate a high-resolution heat map. The system applies a keyframe interpolation algorithm to time-series data. The system generates an animation frame that smoothly connects states between discrete time steps. The system extracts an attention weight matrix from the self-attention mechanism of the transformer model in order to present the determination basis of the artificial intelligence model. The system analyzes the weight matrix. The system identifies an input feature or a spatial region having the highest contribution degree to an output result. The system highlights the identified region in a three-dimensional map model on the dashboard. The system dynamically generates and assigns a reference link to original raw data or statistical information to the highlighted object. With this configuration, the system converts an internal state of a deep learning model, which tends to be a black box, into a format that can be visually interpreted by a human. The system draws a complex city model covering millions of polygons and a simulation result on a browser without delay. The system exhibits a technical effect of reducing a cognitive load on a user and ensuring reliability of an output of the artificial intelligence. The present technology can be applied to a basis presentation system for medical image diagnosis, an algorithm analysis tool for financial transactions, and the like.

Step 6: Automatic Report Generation and Provision to User

A report generation unit automatically creates a report of a current status analysis, issue extraction, a specific measure plan, an expected effect, a risk factor and a countermeasure thereof, a balance evaluation of cost, effect, and risk, necessity of multi-departmental cooperation, an implementation schedule plan, an emergency response flow, and the like based on a simulation result, and enables a city management personnel to view and share the report in PDF or HTML. For example, report contents can be automatically customized according to an application and a user attribute, such as an evacuation plan report for a disaster countermeasure headquarters, a congestion mitigation measure report for a traffic control center, a supply and demand optimization report for an energy supplier, and a human flow control report for an event organizer. Specifically, the report generation unit executes a document construction pipeline combining a dynamic template engine and a natural language generation model. The system acquires an affiliated department, a job title, and a viewing authority level from authentication information of a user. The system selects a structured template defining components of a report from a database based on the attribute information. The system loads numerical data of the simulation result, a uniform resource locator of a generated graph image, and an explanatory text generated by an artificial intelligence onto a memory. The system instructs the natural language generation model to generate a summary sentence suitable for each section of the selected template. The model outputs a text while adjusting a difficulty level of a technical term and a tone of a sentence according to the user attribute. The system inserts the generated text and an image link into a placeholder of the template. The system generates an intermediate document in a markdown format. The system inputs the intermediate document to a document conversion processor. The processor applies a cascading style sheet to calculate a visual layout. The processor generates a final portable document format file or hypertext markup language file. The system saves the generated file in a secure object storage. The system transmits a link with an access right for download to a terminal of the user. With this configuration, the system generates a plurality of different reports optimized for target readers in parallel and instantaneously from the same simulation result. The system completely automates an information sharing process. The system exhibits a technical effect of reducing a communication cost between departments and improving a decision-making speed of the entire organization. The present technology can be applied to automatic generation of a monthly report from a management dashboard of a company, a creation system of a personalized proposal for a customer, and the like.

### (Specific Use Case)

For example, assume a use case in which a disaster countermeasure headquarters of a city formulates a resident evacuation plan in the event of a large-scale earthquake. In this case, the city data integration unit automatically collects various data inside and outside the city such as a real-time traffic sensor of a major intersection or an arterial road, GPS data of a vehicle, road construction or accident information, a capacity and barrier-free status of a shelter, a resident distribution, building earthquake resistance data, an operation status of a medical institution, traffic regulation information in the event of a disaster, a disaster bulletin of the Meteorological Agency or a local government, evacuation information or a confusion status on an SNS, and a past evacuation behavior history, and aggregates the data into an integrated database. The city data integration unit executes data format conversion, timestamp unification, deletion of duplicate data, imputation of missing values, detection and removal of abnormal values, standardization of numerical data, geocoding of geographic information, area classification by clustering, and the like on these data to generate a structured dataset suitable for city management analysis. Specifically, in this use case, the city data integration unit activates an in-memory data processing framework for processing high-frequency data streamed from a heterogeneous distributed environment. The system receives a data stream including spatial coordinates such as global positioning system data of a vehicle and traffic sensor data. The system applies a geohash algorithm to these data in real time. The system converts continuous latitude and longitude information into a discrete spatial grid identifier. The system stores data in a distributed hash table using the spatial grid identifier as a key. The system applies a named entity recognition model to unstructured text data acquired from a social networking service. The system extracts a place name or a facility name included in the text, and executes geocoding to assign coordinate data by collating with an external geographic information system database. The system executes a state estimation algorithm using a Kalman filter in missing value imputation processing. The system dynamically predicts and imputes a temporary data loss due to a communication failure of a sensor or the like from a past transition and an observation value of a peripheral sensor. The system reconstructs the data that has undergone these preprocessings as a multidimensional tensor having spatial and temporal dimensions. The system persists the tensor data in a storage in a columnar format so that a subsequent simulation unit can read the tensor data at high speed. With this configuration, the system maintains a robust data pipeline even under a situation where a time constraint is extremely strict and data quality is unstable, such as when a disaster occurs. The system automatically generates highly reliable structured data from incomplete raw data. The system exhibits a technical effect of ensuring quality of input data, which is a premise of a simulation, and improving fault tolerance of the entire system. The present technology can be applied to an infected person tracking system during a pandemic, a crowd guidance system during a large-scale event, and the like.

Through the user interface unit, a disaster prevention personnel inputs a prompt sentence “simulate an optimal evacuation guidance plan for residents in the event of a large-scale earthquake”. The generative AI scenario simulation unit comprehensively analyzes an earthquake occurrence point, a building damage prediction, road passability, a shelter capacity, a resident distribution, past evacuation behavior data, confusion information on an SNS, an operation status of a medical institution, traffic regulation information, and the like, and outputs how many people should be guided to which shelter via which route, a capacity excess risk for each shelter, a guidance plan for the elderly and disabled considering a barrier-free status, a severely injured person transport route to a medical institution, a distributed guidance plan between shelters, a warning of a congestion occurrence location, a required time prediction until evacuation completion, and the like as a natural language and numerical data. Furthermore, when the disaster prevention personnel inputs an additional prompt such as “recalculate an evacuation guidance plan when a capacity of shelter A is increased”
“re-evaluate a shelter congestion risk when confusion expands on an SNS”, the generative AI immediately executes a re-simulation and outputs an optimal evacuation plan and a risk evaluation after the change. Specifically, the generative AI scenario simulation unit receives the input prompt and the structured dataset, and executes an inference pipeline linking a deep reinforcement learning agent and a large language model. The system defines a road network of a city as a state space in a Markov decision process. The system constructs a graph structure in which each intersection is a node and a road is an edge. The system sets a reward function aiming at minimizing evacuation completion time and avoiding a capacity excess penalty of a shelter for the reinforcement learning agent. An input state tensor to the agent is a three-dimensional tensor including the current number of staying people of each node, a passability flag of a road, and a remaining capacity of a shelter. The agent outputs a probability distribution of an optimal evacuation route using a policy gradient method. The system determines a movement route of each resident group based on the probability distribution. The system generates a numerical array indicating a predicted traffic volume of each road segment and a vector indicating a final capacity of each shelter as a simulation result. The system inputs these numerical data to the large language model. The large language model interprets a meaning of the numerical data and generates a natural language warning sentence such as “a probability that a bottleneck occurs on a route to shelter B is 80 percent”. When receiving an additional prompt “increase capacity of shelter A” from the user, the system updates only a corresponding parameter of the state tensor on an in-memory. The system re-executes only inference processing using a trained reinforcement learning model. The system calculates a new optimal route with a low delay in milliseconds without re-training the model. With this configuration, the system immediately performs recalculation while efficiently using computer resources for a dynamically changing disaster situation. The system processes a complex conditional branch that cannot be handled by a conventional static rule-based evacuation plan. The system exhibits a technical effect of providing an interactive simulation environment and dramatically increasing agility of decision-making. The present technology can be applied to logistics optimization of a military operation, a real-time recalculation system of a dynamic delivery route, and the like.

The city management visualization and interpretation unit displays an evacuation route output by the generative AI color-coded on a map, indicates a capacity status and a barrier-free status of a shelter with an icon, displays a warning for a highly congested route or shelter, and also visualizes a transport route to a medical institution and an installation location of a relief station. Furthermore, the city management visualization and interpretation unit displays a determination basis and a thinking process of the AI as an explanatory text or a link to basis data on a dashboard so that a personnel can make a decision convincingly. Specifically, the city management visualization and interpretation unit executes a dynamic rendering pipeline linked with a geographic information system engine. The system receives coordinate array data of an evacuation route output by the generative artificial intelligence. The system converts the coordinate data into a vector tile format. The system assigns an attribute of a color code and a line thickness according to a predicted congestion degree score to each route segment. The system streams these vector tile data to a drawing library operating on a web browser of a client terminal. The system dynamically generates and overlays a pie chart indicating a capacity rate or a vector image indicating a barrier-free status on point data of a shelter or a medical institution. The system extracts a state value score of each node from a value function network of a reinforcement learning agent in order to visualize the determination basis of the artificial intelligence. The system superimposes and draws the score as a three-dimensional contour map on the map. The system triggers an event listener when a user clicks a specific evacuation route. The system asynchronously acquires and displays a generated text of a large language model indicating a reason why the route is selected and a hyperlink to input data serving as a basis (for example, road closure information of a specific road) in a pop-up window. With this configuration, the system presents a complex multidimensional simulation result as intuitive graphics optimized for human visual characteristics. The system transparently discloses an inference process inside a computer, not limited to a mere display of a result. The system exhibits a technical effect of resolving a black box problem and technically ensuring reliability of a user on a system output. The present technology can be applied to a visualization interface of an action plan of an autonomous driving vehicle, a risk analysis dashboard of a complex financial portfolio, and the like.

The report generation unit automatically creates a report of a current status analysis, issue extraction, a specific evacuation guidance measure plan, an expected effect, a risk factor and a countermeasure thereof, an implementation schedule plan, an emergency response flow, and the like based on a simulation result, and enables a disaster countermeasure headquarters and a related department to view and share the report in PDF or HTML. Specifically, the report generation unit executes a document generation process by a batch processing architecture using an asynchronous task queue. The system receives an event notification of simulation completion. The system acquires a structured dataset of a simulation result from a message broker. The system divides the dataset into chunks according to an input context size of a natural language generation model. The system inputs each chunk to the natural language generation model in parallel. The system simultaneously generates a text of each section such as a current status analysis, issue extraction, and a measure plan in an independent thread. The system combines the generated texts of each section. The system applies an evaluation model for verifying continuity of context and logical consistency to the combined text. The system automatically verifies whether numerical data included in the text completely matches tensor data of an original simulation result using a regular expression and a rule-based collation engine. The system pours text data that has passed the verification into a predefined hypertext markup language template. The system activates an instance of a headless browser in a background. The system renders the hypertext markup language, automatically calculates a page break and a table of contents, and outputs a portable document format file. The system saves the generated file in a distributed file system. The system automatically transmits a notification email including a uniform resource identifier of the file to a mailing list of a related department. With this configuration, the system efficiently executes document generation processing with a high calculation load in a distributed manner in a background. The system generates a high-quality report in a short time without hindering an interactive operation of a user. The system exhibits a technical effect of minimizing a delay in information sharing in an emergency and improving an organizational response speed. The present technology can be applied to automatic generation of an incident report at the time of a system failure, a creation system of a regular compliance audit report, and the like.

In such a use case, specific examples of a prompt sentence to be read by a generative AI include “simulate an optimal evacuation guidance plan for residents in the event of a large-scale earthquake”, “recalculate an evacuation guidance plan when a capacity of shelter A is increased”, “re-evaluate a shelter congestion risk when confusion expands on an SNS”, “propose an evacuation guidance plan considering a barrier-free status for the elderly and disabled”, and “optimize a severely injured person transport route to a medical institution”. Based on these prompts, the system of the present invention integrates and analyzes various data of an entire city, integrally realizes an advanced scenario simulation by a generative AI, intuitive visualization, basis explanation, and automatic report generation, and can support prompt and highly convincing decision-making of a disaster countermeasure headquarters. Specifically, the system executes a multi-stage natural language processing pipeline including an intent classifier and a parameter extractor in order to process these various prompt sentences. The system maps an input prompt sentence to a vector space. The system determines which task class of “route optimization”, “risk evaluation”, and “resource reallocation” an intent of a prompt belongs to using cosine similarity calculation. The system dynamically switches an algorithm to be executed by a subsequent simulation engine (for example, a route search based on Dijkstra's algorithm, a probabilistic risk evaluation by a Monte Carlo method, resource allocation by linear programming, and the like) according to the determined task class. The system mathematically formulates a constraint condition extracted from a prompt (for example, “barrier-free status”, “severely injured person transport”, and the like) as a penalty term or a weighting coefficient for an objective function of an algorithm. With this mechanism of dynamic algorithm selection and parameter setting, the system seamlessly executes extremely diverse calculation tasks from a single user interface. The system closely links each processing module (data integration, simulation, visualization, report generation) via an application programming interface. The system constructs an end-to-end pipeline that autonomously executes all processes from data input to final report output without human intervention. With this configuration, the system realizes cross-disciplinary data analysis and complex scenario evaluation, which have been impossible with a conventional siloed city management system. The system reduces latency of large-scale data processing to the utmost limit through efficient orchestration of computer resources. The system exhibits a technical effect of improving resilience of city infrastructure and establishing a data-driven scientific decision-making process. The present technology can be widely applied as a base technology of an integrated operating system of a smart city or a crisis management platform at a national level.

The specific processing unit 290 sends the results of specific processing obtained in Example 1 or Application Example 1 described above to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence).

An example of the data generation model 58 is a generative AI such as ChatGPT (registered trademark) (Internet search <URL: https://openai.com/blog/chatgpt>).

The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart device 14.

### Second Embodiment

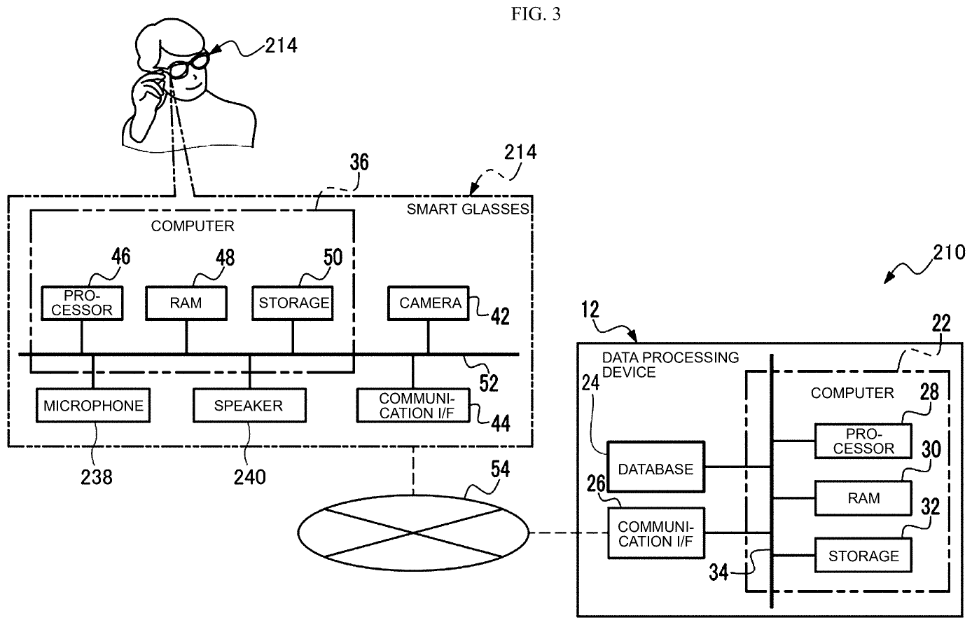

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, camera 42, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

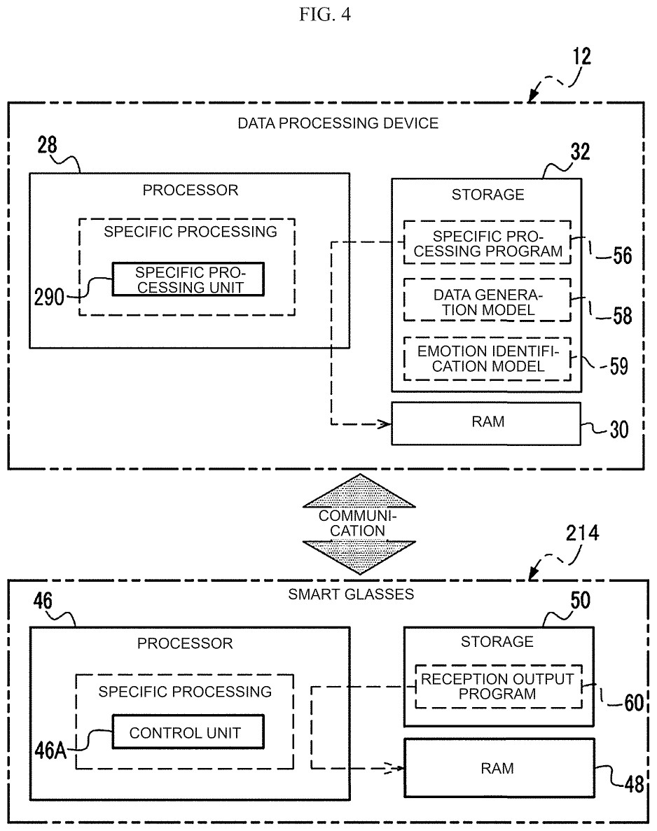

FIG. 4 shows an example of the main functions of the data processing device 12 and smart glasses 214. As shown in FIG. 4, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, and various estimations and predictions related to the user's emotions are performed, but it is not limited to such examples. Furthermore, emotion estimation and prediction may include, for example, emotion analysis.

In the smart glasses 214, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48. The smart glasses 214 may also have similar data generation models and emotion identification models as the data generation model 58 and emotion identification model 59, and perform the same processing as the specific processing unit 290 using these models.

Next, specific processing by the specific processing unit 290 of the data processing device 12 will be described. Each part of the system described below is realized by the data processing device 12 and the smart glasses 214. In the following description, the data processing device 12 is referred to as a “server,” and the smart glasses 214 are referred to as a “terminal.”

### Example 1

Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

In the above embodiments, an example form where specific processing is performed by the data processing device 12 was described, but the technology disclosed herein is not limited to this, and specific processing may be performed by the smart glasses 214.

### Third Embodiment

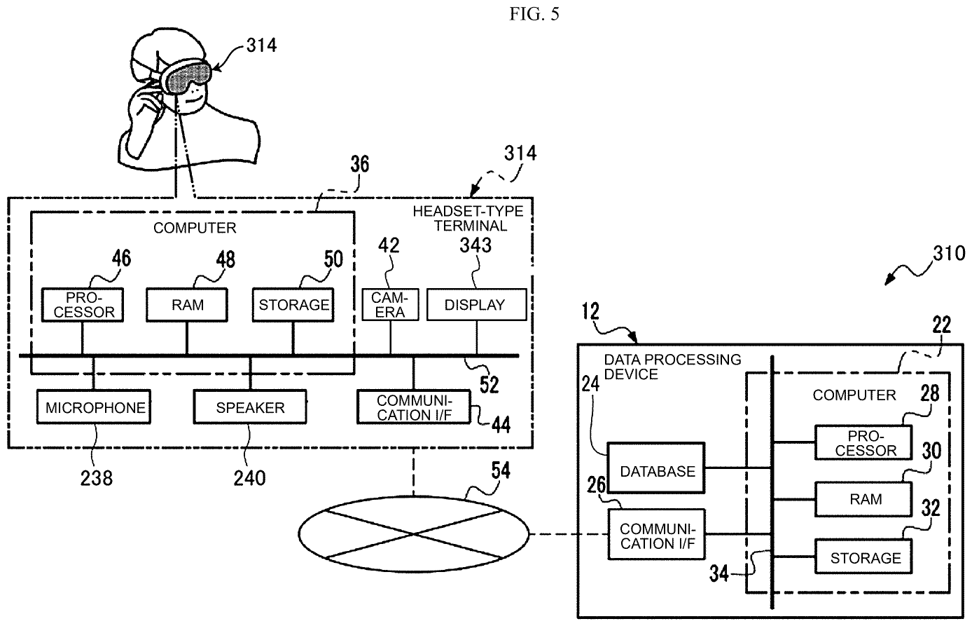

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, display 343, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

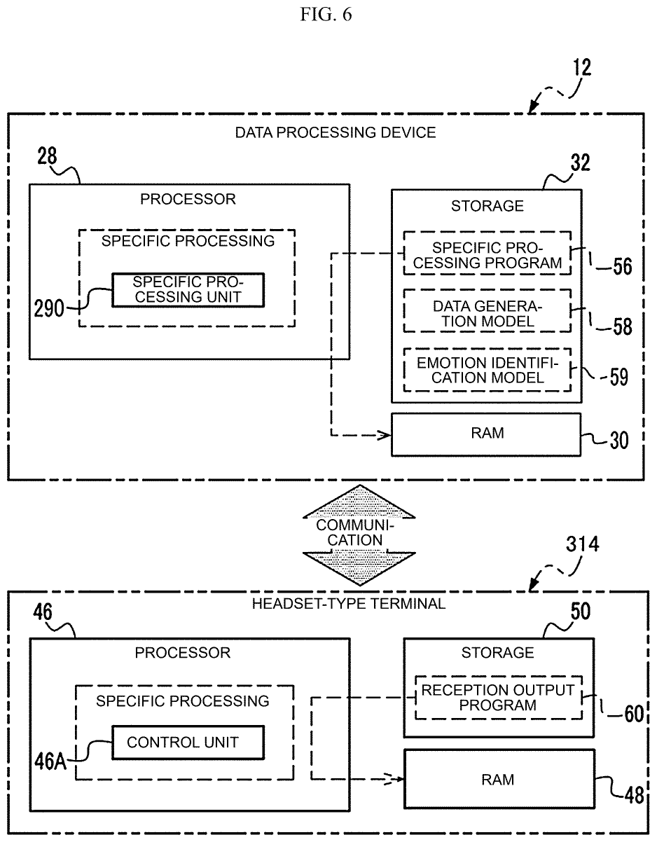

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the headset-type terminal 314, reception output processing is performed by the processor 46.

The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the headset-type terminal 314. In the following description, the data processing device 12 is referred to as a “server,” and the headset-type terminal 314 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

In the above embodiments, an example form where specific processing is performed by the data processing device 12 was described, but the technology disclosed herein is not limited to this, and specific processing may be performed by the headset-type terminal 314.

### Fourth Embodiment

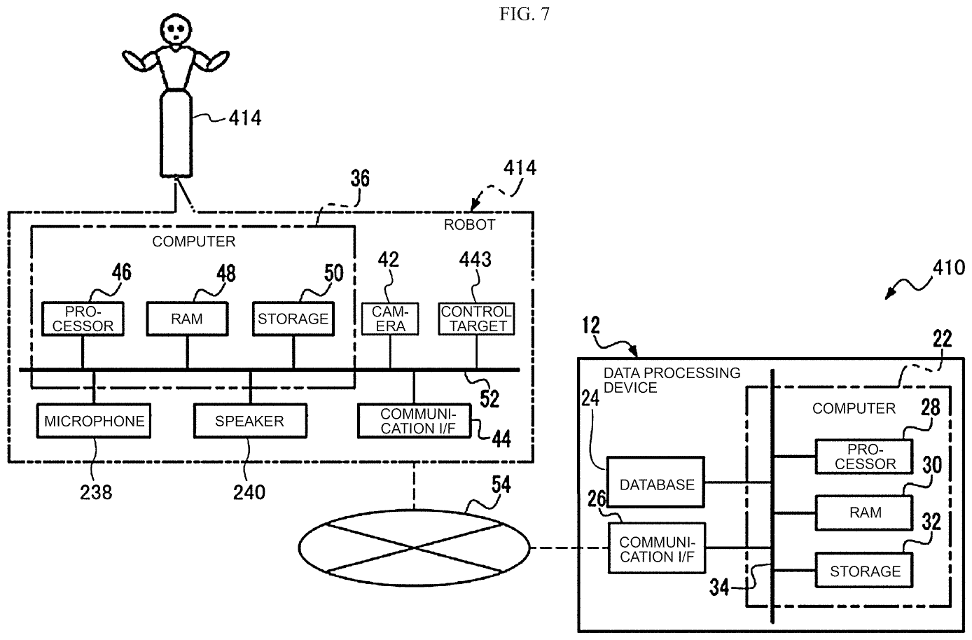

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 is an example of a “computer” related to the technology disclosed herein. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, control target 443, and communication I/F 44 are also connected to the bus 52.

The microphone 238 accepts voice uttered by the user 20, accepting instructions, among others, from the user 20. The microphone 238 captures the voice emitted by the user 20, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user 20 (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

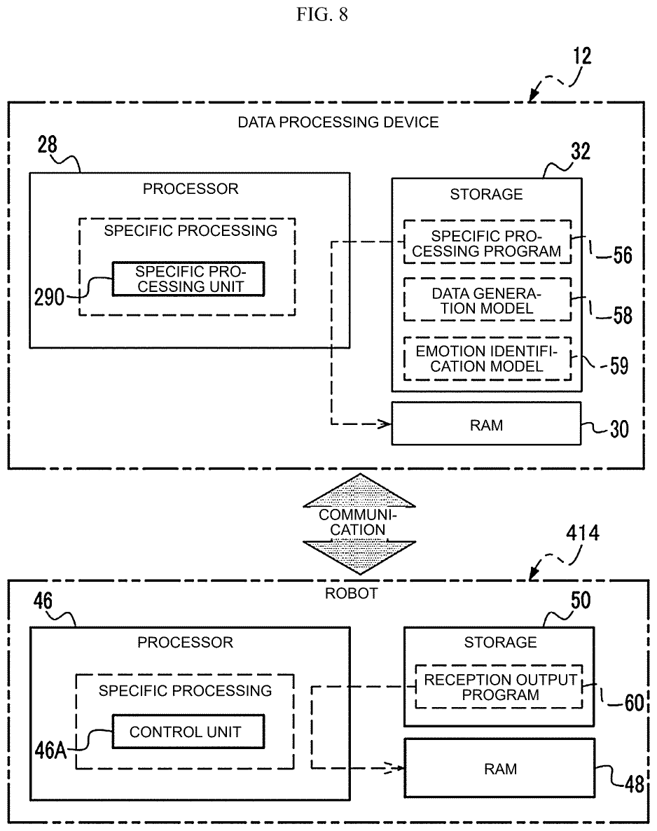

FIG. 8 shows an example of the main functions of the data processing device 12 and the robot 414. As shown in FIG. 8, specific processing is performed in the data processing device 12 by the processor 28. The storage 32 stores a specific processing program 56.

The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290.

In the robot 414, reception output processing is performed by the processor 46. The storage 50 stores a reception output program 60. The processor 46 reads the reception output program 60 from the storage 50 and executes it on the RAM 48. The reception output processing is realized by the processor 46 operating as a control unit 46A according to the reception output program 60 executed on the RAM 48.

Next, specific processing by the specific processing unit 290 of the data processing device 12 will be described. Each part of the system described below is realized by the data processing device 12 and the robot 414. In the following description, the data processing device 12 is referred to as a “server,” and the robot 414 is referred to as a “terminal.”

(Example 1) Since the flow of the specific processing is the same as that in Example 1 described in the first embodiment, the description thereof is omitted.

(Application Example 1) Since the flow of the specific processing is the same as that in Application Example 1 described in the first embodiment, the description thereof is omitted.

The specific processing unit 290 sends the results of specific processing obtained in Example 1 or Application Example 1 described above to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

Moreover, the processing by the data processing system 10 described above is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

In the above embodiments, an example form where specific processing is performed by the data processing device 12 was described, but the technology disclosed herein is not limited to this, and specific processing may be performed by the robot 414.

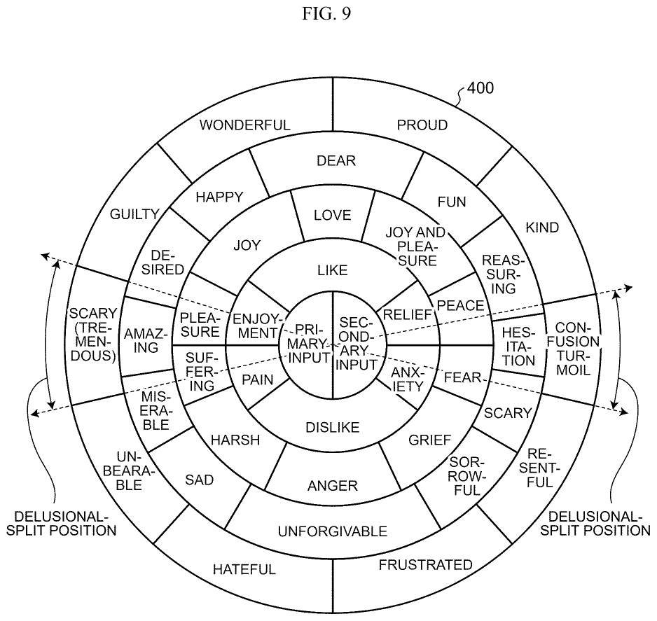

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

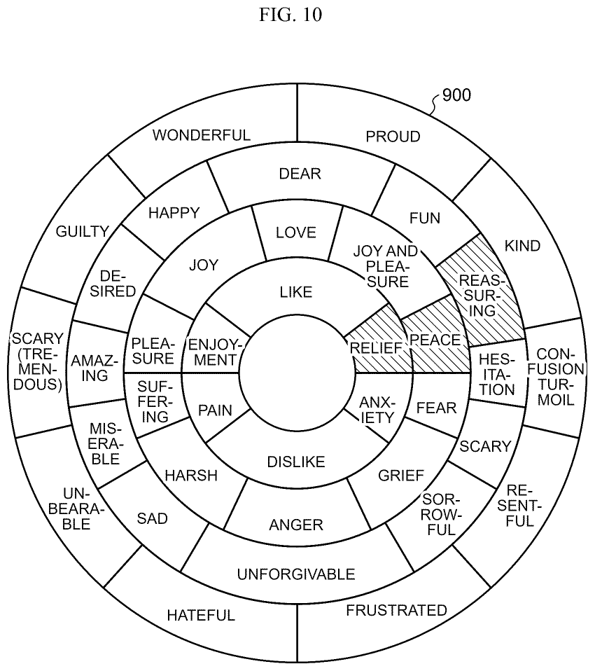

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above, the system according to the present disclosure has been described mainly on the functions of the data processing device 12, but the system according to the present disclosure is not necessarily mounted on a server. The system according to the present disclosure may be implemented as a general information processing system. The present disclosure may be implemented, for example, as a software program running on a personal computer, or an application running on a smartphone or the like. The method according to the present disclosure may be provided to the user in the form of SaaS (Software as a Service).

In the above embodiments, an example form where specific processing is performed by a single computer 22 was described, but the technology disclosed herein is not limited to this, and distributed processing for specific processing by multiple computers including the computer 22 may be performed. For example, the data generation model 58 may be provided in an external device of the data processing device 12, and the external device may generate data corresponding to the input data.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned.

Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.

Note that the following supplementary notes are further disclosed regarding the above description.

### (Supplementary Note 1)

A system comprising: a city data integration unit; a generative AI scenario simulation unit; and a city management visualization and interpretation unit, wherein the city data integration unit is configured to automatically collect data from various data sources inside and outside the city such as traffic volume data, energy consumption data, environmental sensor data, public transportation operation data, resident behavior logs, social media data, disaster information, and economic indicators, perform preprocessing such as data format conversion, timestamp unification, deletion of duplicate data, imputation of missing values, detection and removal of abnormal values, standardization of numerical data, smoothing and moving average of time-series data, geocoding of geographic information, and area classification by clustering to generate a structured dataset suitable for city management analysis; the generative AI scenario simulation unit is configured to receive the structured dataset and a city management scenario prompt input in a natural language by a user, multidimensionally simulate a plurality of scenarios related to city management such as evacuation guidance in the event of a disaster, traffic congestion mitigation, energy supply and demand optimization, human flow control during an event, and environmental load reduction measures using a generative AI, and output an optimal measure plan, an effect prediction, a risk evaluation, basis data, a comparison with past cases, a comparison of a plurality of plans, and the like as a natural language and numerical data; and the city management visualization and interpretation unit is configured to display the measure plan, the effect prediction, the risk evaluation, and the like for each scenario output by the generative AI as an evacuation route display on a map, a congestion degree heat map, a time-series graph, an effect comparison chart for each measure plan, a contribution degree graph of a risk factor, and the like on a dashboard, display a determination basis and a thinking process of the AI together as an explanatory text or a link to basis data, further automatically create a report of a current status analysis, issue extraction, a specific measure plan, an expected effect, a risk factor and a countermeasure thereof, and the like based on a simulation result, and enable a city management personnel to view and share the report in PDF or HTML.

### (Supplementary Note 2)

The system according to Supplementary Note 1, wherein the generative AI scenario simulation unit is configured to, in response to an additional prompt from the user, execute a detailed scenario analysis specifying a specific element or condition related to city management such as an excess risk of shelter capacity in the event of a disaster, a reduction effect of a traffic congestion occurrence rate, a power saving request timing at a power peak, and a congestion degree change around an event venue in real time using the generative AI, and output an explanation including basis data and a comparison with past cases in a natural language.

### (Supplementary Note 3)

The system according to Supplementary Note 1, wherein the city management visualization and interpretation unit is configured to, when the city management personnel changes a scenario condition or a measure plan on the dashboard based on the scenario simulation result output by the generative AI, immediately re-prompt the generative AI with the changed content, re-display a re-simulation result in real time as a map, a graph, a chart, and an explanatory text, and further automatically create a report of the content and output the report in a PDF or HTML format.

What is claimed is:

1. A system comprising:
circuitry configured to:
receive, via a communication interface coupled to a packet-switched network, heterogeneous data streams from a plurality of internal and external data source systems, apply preprocessing operations comprising duplicate removal, missing value imputation, anomaly value detection and removal, and numerical standardization to the heterogeneous data streams, and aggregate the preprocessed data into an integrated database in the storage device;
apply a feature extraction and dimensionality reduction pipeline to the integrated database to generate a structured dataset, and construct a digital twin environment on a cloud computing node by ingesting the structured dataset into a hybrid AI model comprising a deep reinforcement learning algorithm and a large language model;
execute agent-based simulations in a virtual space of the digital twin environment conditioned on scenario parameter data received from a terminal device via the communication interface, and generate simulation output data comprising future state prediction vectors and risk analysis data records for each scenario parameter set;
apply the large language model to the simulation output data and the scenario parameter data to generate a natural language scenario analysis record comprising future prediction summaries and risk analysis text; and
transmit the simulation output data, the natural language scenario analysis record, and visualization data generated from the digital twin environment to terminal devices via the communication interface.

2. The system according to claim 1, wherein the circuitry is configured to receive data from financial accounting systems, user behavior log data, external news article data streams, and economic indicator data services via the communication interface, convert data transmitted in heterogeneous protocols into a standardized message format, and cache the converted data in an in-memory database for real-time query processing.

3. The system according to claim 2, wherein the circuitry is configured to apply a natural language processing model to unstructured text data comprising news article records and social media data streams to extract named entity labels, sentiment polarity scores, and trend indicator features, and incorporate the extracted features as structured attributes in the integrated database alongside numerical data fields.

4. The system according to claim 1, wherein the circuitry is configured to apply a dimensionality reduction algorithm to the feature-extracted integrated dataset to generate a compact structured dataset having a reduced feature space dimensionality, execute parallel processing of the compact structured dataset across a plurality of computing nodes using a distributed computing framework, and store the processed results in the integrated database.

5. The system according to claim 1, wherein the circuitry is configured to receive scenario parameter data in natural language from a terminal device via the communication interface, apply the large language model to extract structured scenario parameters comprising numerical constraint values and categorical condition identifiers from the natural language scenario parameter data, and condition the digital twin environment on the extracted structured scenario parameters for simulation execution.

6. The system according to claim 5, wherein the circuitry is configured to execute agent-based simulations in the virtual space by instantiating a plurality of autonomous agents with behavioral policy parameters derived from historical data patterns, apply the deep reinforcement learning algorithm to optimize agent actions according to an objective function defined by the structured scenario parameters, and aggregate agent state trajectories to generate the future state prediction vectors.

7. The system according to claim 6, wherein the circuitry is configured to apply the deep reinforcement learning algorithm by encoding the current digital twin environment state as an input tensor, computing action-value estimates for each possible simulation step, selecting simulation actions maximizing cumulative reward according to the objective function, and updating the digital twin environment state after each simulation step.

8. The system according to claim 1, wherein the circuitry is configured to input voxel data indicating a three-dimensional spatial model, traffic volume tensors representing flow rates at network nodes, and multidimensional weather forecast arrays as input data to the hybrid AI model, and generate scalar efficiency metrics, spatial heat map matrices, and flow optimization parameter vectors as simulation output data.

9. The system according to claim 1, wherein the circuitry is configured to generate comparative scenario analysis data by executing simulations for a plurality of distinct scenario parameter sets, applying the large language model to generate comparative analysis text ranking the scenario parameter sets by aggregate outcome score, and transmitting the comparative scenario analysis data to the terminal device as a ranked scenario comparison report.

10. The system according to claim 9, wherein the circuitry is configured to retrieve historical scenario records from a vector database by cosine similarity search using a query embedding vector derived from the current scenario parameter data, and incorporate the retrieved historical scenario records as reference context in the large language model prompt for comparative analysis text generation.

11. The system according to claim 1, wherein the circuitry is configured to generate visualization data from the digital twin environment comprising spatial heat maps of predicted state distributions, time-series charts of key metric trajectories, and flow diagrams of resource allocation patterns, and transmit the visualization data as structured rendering data to terminal devices for display in a dashboard interface.

12. The system according to claim 1, wherein the circuitry is configured to apply a self-learning update procedure to the digital twin environment model at configurable intervals by extracting new training examples from recently received data streams and corresponding validated outcome records, and fine-tuning the hybrid AI model to reduce prediction error on the most recent data window.

13. The system according to claim 1, wherein the circuitry is configured to receive natural language query data from a terminal device referencing a specific simulation result, apply the large language model to generate a detailed natural language explanation of the referenced simulation result, and transmit the natural language explanation to the terminal device via the communication interface.

14. The system according to claim 1, wherein the circuitry is configured to generate automated summary report data from simulation output data and natural language scenario analysis records at configurable periodic intervals, and transmit the automated summary report data to terminal devices associated with designated recipient user identifiers.

15. The system according to claim 1, wherein the circuitry is configured to apply a risk quantification model to the risk analysis data records to compute risk severity scores and risk probability scores for each identified risk factor, rank risk factors in descending order of a combined risk metric, and incorporate the ranked risk factors in the natural language scenario analysis record.

16. The system according to claim 1, wherein the circuitry is configured to store all scenario parameter data, simulation output data, and natural language scenario analysis records in an audit log data structure with timestamps and session identifiers, and generate a model performance report by comparing historical future state prediction vectors against subsequently observed outcome data.

17. The system according to claim 1, wherein the heterogeneous data streams comprise time-series operational records, user behavior logs, and external data feeds from economic indicator services, the digital twin environment models a dynamic system as a virtual space, and the agent-based simulations represent interaction dynamics among system components under the specified scenario parameters.

18. A system comprising:
circuitry configured to:
receive, via a communication interface coupled to a packet-switched network, heterogeneous data streams from internal and external data sources, apply preprocessing and feature extraction to generate a structured dataset, and construct a digital twin environment using a hybrid AI model comprising deep reinforcement learning and a large language model;
receive scenario parameter data in natural language, extract structured scenario parameters using the large language model, and execute agent-based simulations conditioned on the extracted parameters;
generate future state prediction vectors and risk analysis data records from simulation output, and apply the large language model to generate natural language scenario analysis records; and
transmit simulation output data, natural language scenario analysis records, and visualization data to terminal devices via the communication interface.

19. The system according to claim 18, wherein the circuitry is configured to retrieve historical scenario records from a vector database by cosine similarity search to incorporate as reference context in comparative scenario analysis, apply a risk quantification model to compute ranked risk severity and probability scores, and apply a self-learning update procedure to fine-tune the hybrid AI model on recently validated outcome records.

20. A method comprising:
receiving, via a communication interface coupled to a packet-switched network, heterogeneous data streams from a plurality of data source systems, applying preprocessing operations to aggregate the data into an integrated database, and applying feature extraction and dimensionality reduction to generate a structured dataset;
constructing a digital twin environment on a cloud computing node using a hybrid AI model comprising a deep reinforcement learning algorithm and a large language model, and executing agent-based simulations conditioned on scenario parameter data received from a terminal device;
generating simulation output data comprising future state prediction vectors and risk analysis data records, and applying the large language model to generate a natural language scenario analysis record; and
transmitting the simulation output data, the natural language scenario analysis record, and visualization data to terminal devices via the communication interface.
